(19) United States
(12) Patent Application Publication
(10) Pub. No.: US 2026/0304367 A1
(43) Pub. Date: Oct. 1, 2026

(54) QUERYING PROTOCOLS FOR DEVICE POSITIONING

(71) Applicant: QUALCOMM Incorporated, San Diego, CA (US)

(72) Inventors: Varun Amar REDDY, San Diego, CA (US); Amit GOEL, San Diego, CA (US)

(21) Appl. No.: 19/578,717

(22) Filed: Mar. 25, 2026

Related U.S. Application Data
(60) Provisional application No. 63/779,123, filed on Mar. 27, 2025.

(51) Int. Cl. H04W 64/00

(52) U.S. Cl. CPC H04W 64/00

(57) ABSTRACT

A management entity (ME) for wireless devices may determine a first query list for querying a first subset of the wireless devices for positioning information of target devices, the first query list based on one or more characteristics of the wireless devices. The ME may receive the positioning information of one or more target devices responsive to one or more queries to the first subset, the positioning information having measurements of radio frequency (RF) signals transmitted by the one or more target devices, the measurements made by at least one wireless device of the first subset. The ME may determine a second query list for querying a second subset of the wireless devices for additional positioning information of the one or more target devices, the second query list based at least in part on the positioning information of one or more target devices.

### RELATED APPLICATIONS

This application claims the benefit of U.S. Provisional Application No. 63/779,123, filed Mar. 27, 2025, entitled “QUERYING PROTOCOLS FOR DEVICE POSITIONING,” which is assigned to the assignee hereof, and incorporated herein in its entirety by reference.

### BACKGROUND

### 1. Field of Disclosure

The present disclosure generally relates to wireless communications and, more specifically, to communication between wireless communication devices (e.g., electronic shelf labels (ESLs) and/or other wireless communication devices) for energy-efficient positioning (e.g., of an electric tag (eTag)).

### 2. Description of Related Art

Low-power communication technologies, such as Bluetooth® Low Energy (BLE), can allow devices to communicate wirelessly for various purposes. This can include, for example, positioning, proximity marketing, or other purposes. In some cases, such devices may serve as nodes (e.g., relay nodes) of a wireless mesh network that communicates and/or relays information, such as measurements or other information regarding the position of a device, to a managing platform or hub associated with the wireless mesh network.

### BRIEF SUMMARY

An example method at a management entity of coordinating communication from a plurality of wireless devices, according to this disclosure, comprises determining a first query list for querying a first subset of the plurality of wireless devices for positioning information of one or more target devices, the first query list based at least in part on one or more characteristics of the plurality of wireless devices. The method further comprises receiving the positioning information of one or more target devices responsive to one or more queries to the first subset of the plurality of wireless devices, the positioning information comprising measurements of radio frequency (RF) signals transmitted by the one or more target devices, the measurements made by at least one wireless device of the first subset of the plurality of wireless devices. The method also comprises determining a second query list for querying a second subset of the plurality of wireless devices for additional positioning information of the one or more target devices, the second query list based at least in part on the positioning information of one or more target devices.

An example management entity, according to this disclosure, comprises at least one transceiver, at least one memory, and at least one processor communicatively coupled with the at least one transceiver and the at least one memory. The at least one processor is configured to determine a first query list for querying a first subset of a plurality of wireless devices for positioning information of one or more target devices, the first query list based at least in part on one or more characteristics of the plurality of wireless devices;
receive, via the at least one transceiver, the positioning information of one or more target devices responsive to one or more queries to the first subset of the plurality of wireless devices, the positioning information comprising measurements of radio frequency (RF) signals transmitted by the one or more target devices, the measurements made by at least one wireless device of the first subset of the plurality of wireless devices; and
determine a second query list for querying a second subset of the plurality of wireless devices for additional positioning information of the one or more target devices, the second query list based at least in part on the positioning information of one or more target devices.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a generic block diagram of a wireless communication and positioning system that can be utilized in the embodiments described herein.

FIG. 2 is an illustration of an example electronic shelf label (ESL) system deployed within a retail store, according to an embodiment.

FIG. 3 is an illustration of various views of an example wireless communication device rail, according to an embodiment.

FIG. 4 is a diagram of an example configuration in which ESLs and ESL radios are installed on shelves of a gondola.

FIG. 5 is a diagram of an example of position estimation of an electronic tag (eTag), according to an embodiment.

FIG. 6 is a signaling diagram of an example of periodic advertising with responses (PAwR) for a group of wireless devices, according to an embodiment.

FIG. 7 is an example signaling diagram that shows the transmission (Tx) and reception (Rx) of communication packets in accordance PAwR protocol, according to an embodiment.

FIG. 8 is a diagram illustrating how embodiments may utilize a new transmission (Tx) scheme, according to some embodiments.

FIG. 9 is a sequence of illustrations providing an example of how different clusters of ESL radios may be queried at different times, according to an embodiment.

FIG. 10 is a message flow diagram illustrating a PAwR-based process of obtaining positioning measurements performed by one or more wireless devices, according to an embodiment.

FIG. 11 is a message flow diagram illustrating a connection-oriented generic attribute profile (GATT) protocol-based process of obtaining positioning measurements performed by one or more wireless devices, according to an embodiment.

FIG. 12 is a flow diagram of a method at a management entity of coordinating communication from a plurality of wireless devices.

FIG. 13 is a diagram illustrating example components of a device, in accordance with the present disclosure.

FIG. 14 is an example block diagram of a radio frequency (RF) energy harvesting device, in accordance with some examples.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) 802.15.4 standards for ultra-wideband (UWB), IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multiple channels or paths. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

Further, unless otherwise specified, the term “positioning” as used herein may include absolute location determination, relative location determination, ranging, or a combination thereof. Such positioning may include and/or be based on timing, angular, phase, or power measurements, or a combination thereof (which may include RF sensing measurements) for the purpose of location or sensing services. A device or object for which a position is being determined may be referred to as a “target,” “target device,” “target object,” or the like. The device or node used in the positioning of a target may be referred to as an “anchor,” “anchor device,” “anchor node,” or the like.

Retail companies plan to deploy wirelessly-controlled Electronic Shelf Labels (ESLs) so that product information on store shelves can be displayed digitally and changed on the fly. ESL radios may use low-power communication technology such as Bluetooth® Low Energy (BLE) to update label information. Additionally, the ESL radio infrastructure may be repurposed and used for the positioning of devices, in which ESLs can provide a highly dense network of anchor nodes (nodes with which a device may be positioned) that can achieve sub-meter accuracy of devices in retail-store settings, typically with constraints on power consumption (since ESLs are often battery-powered). However, the low-power communication technologies, including BLE, may not directly enable positioning in this manner because it can require larger amounts of data (containing measured RSSI or other RF measurements) to be reported by ESLs to a server via an ESL access point (AP).

Embodiments provided herein address these and other issues. Various aspects generally relate to modifying protocol between ESL radios and an ESL AP to allow for the transfer of the larger amounts of data associated with RF measurements in an over-the-top (OTT) manner (without resulting in changes to the relevant (e.g., BLE) specification(s). Some aspects more specifically relate to ESL radios configured to transmit information to an ESL AP such that a single radio may use contiguous time slots typically reserved for multiple radios in order to report larger packets of data (e.g., measurement data). As discussed in the embodiments herein, ESL radios may be grouped based on spatial separation, and reporting may be such that ESL radios of a first group of spatially separated radios may perform reporting such that each radio in the group occupies slots typically reserved for other, spatially separate radios of the group. Additionally or alternatively, a management entity (ME) may form initial query lists (initial groups of ESL radios for reporting) from ESL radios based on various factors such as spatial interleaving, temporal interleaving, remaining battery life, and/or other such factors, or any combination thereof. Updated query lists may also be performed based on various factors such as distance, target device prioritization, allowable duration (e.g., slot) allocated reserved for each at ESL radio, position accuracy requirements, receiving (Rx) scanning pattern, pending amount of data to be sent, and/or other factors, or any combination thereof. According to some embodiments, to further reduce overhead, an ESL radio may filter data before reporting it in accordance with any of a variety of factors, such as age of measurement, type of measurement, value of measurement, uncertainty metrics, statistics, type of target device, and/or other such factors, or any combination thereof. Moreover, according to some embodiments, such filtering may be implemented by ESL radios in accordance with commands received from another entity, such as an ESL AP. According to some embodiments, techniques disclosed herein can leverage existing generic attribute profile (GATT)-based and/or periodic advertising with responses (PAwR)-based protocols used in BLE or other low-power wireless technologies. These and other embodiments are described in more detail below. Further, although embodiments are generally focused on ESL radios, it will be understood by a person of ordinary skill in the art that other types of radios and/or devices may be used in other embodiments. That is, embodiments are not necessarily limited to ESL radios, ESL APs, retail environments, etc., and may be expanded to other device types, environments, etc.

Particular aspects of the subject matter described in this disclosure can be implemented to realize one or more of the following potential advantages. In some examples, by allowing for larger packets to be reported, embodiments can enable accurate positioning of target devices and may leverage current protocols to do so. Further, by coordinating reporting by radios based on various criteria (e.g., amount of data to be sent) and/or enabling filtering of data to be reported, embodiments may allow for savings in overhead. Ultimately, embodiments disclosed herein enable the efficient use of wireless resources to perform accurate, low-latency positioning using existing networks, devices, and protocols. A detailed description of such embodiments is provided below, after a discussion of relevant devices and networks.

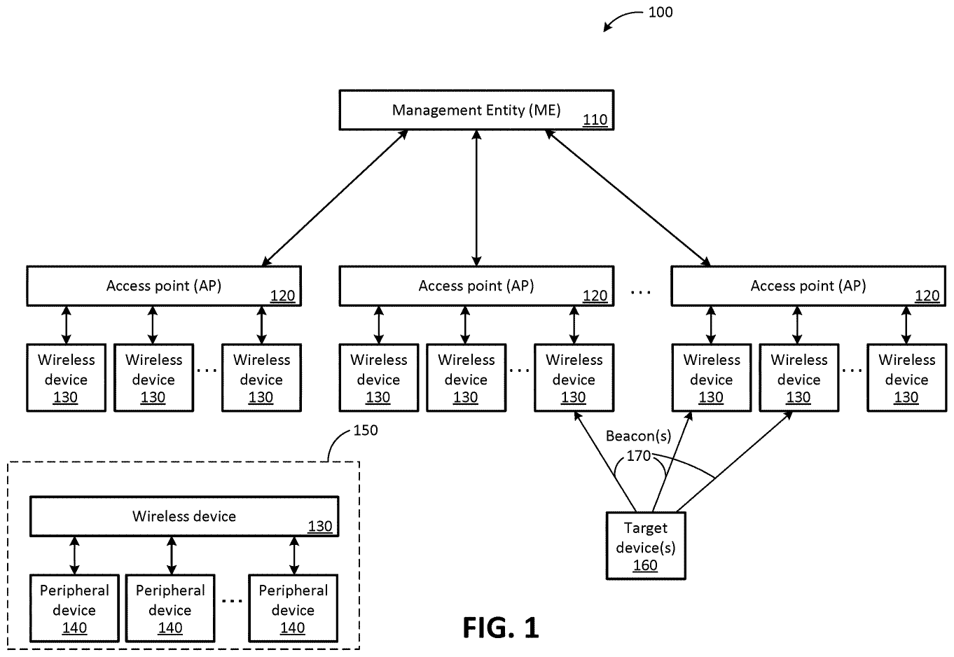

FIG. 1 is a generic block diagram of a wireless communication and positioning system 100 that can be utilized in the embodiments described herein. Various devices are illustrated as blocks, and communication links between devices are illustrated as arrows. Depending on desired functionality, different communication links (represented by different arrows) may be implemented by different communication technologies, including different wired and/or wireless technologies. This system 100 may be seen as a generic description of an ESL system as described further below. Again, embodiments may be extended to non-ESL systems, which may generally have the architecture illustrated in FIG. 1. Further, although the system 100 illustrates a hierarchical design with each component having a plurality of subcomponents, it can be noted that any level may have any number of components, including a larger or smaller number than illustrated in FIG. 1. Moreover, devices may be combined and/or separated such that different levels of the hierarchy illustrated in FIG. 1 are correspondingly combined and/or separated. Moreover, communication relates (illustrated as arrows) may include intervening devices, relays, and/or networks. A person of ordinary skill in the art will appreciate the usage of such features in various applications. Further, the system 100 itself may be coupled with devices and/or networks, such as the Internet, to enable control/management of the system 100 from any location via a device communicatively coupled with the system 100 such devices and/or networks.

As illustrated, the system 100 may be managed using a management entity (ME) 110. In various embodiments, including ESL systems, the ME 110 may be implemented by a computer server. According to some embodiments, including an ESL system deployed in one or more facilities, the ME 110 may be implemented by an edge server located in or near the facility(ies) where the various other components of the system 100 are located.

The ME 110 may be communicatively coupled with one or more access points (APs) 120, as illustrated in FIG. 1. The APs 120 may comprise wireless devices deployed, for example, within one or more facilities within the coverage area of the system 100. As illustrated, each AP 120 may communicate with one or more wireless devices 130. The wireless devices 130 may utilize the low-powered wireless technology (e.g., BLE) described herein to perform positioning and/or communication. In an ESL system, such as those described below, an AP 120 may be referred to as an “ESL AP,” and the wireless device(s) 130 with which ESL APs are connected may comprise ESL radios. That said, APs 120 (including ESL APs) may communicate with wireless devices that do not comprise ESLs. In other words, the communication system 100 may manage and/or communicate with wireless devices in addition or as an alternative to ESLs.

According to some embodiments, each wireless device 130 may further manage, communicate with, and/or receive RF signals from one or more peripheral devices 140, as illustrated by callout box 150. According to embodiments herein, peripheral devices 140 may include ESLs. For example, in an ESL system, a wireless device 130 comprising an ESL radio may communicate with one or more ESLs, causing ESLs to display particular label information (e.g., item name, price, etc.). Communication between the wireless device 130 and the peripheral device(s) 140 may be wired and/or wireless, depending on desired functionality.

The system 100 further may be capable of performing positioning of one or more target devices 160. As described in further detail below, a target device may comprise an electronic device configured to transmit one or more beacons 170 that can be measured by one or more wireless devices 130. Measurements of these beacons can then be used to determine a position estimate for the target device(s) 160. According to some embodiments, measurements may be sent from wireless devices 130 to corresponding APs 120 and/or the ME 110, enabling the APs 120/ME 110 to determine a position estimate of the target device(s) 160. Depending on the circumstances of each scenario, one or more beacons transmitted by a target device 160 may be received from one or more wireless devices 130, and different wireless devices 130 may be associated with different APs 120, as shown in FIG. 1. Other circumstances may be different. For example, beacon(s) 170 may be received by a single wireless device 130, or multiple wireless devices 130 associated with a single AP, etc.

To be clear, each block in the system 100 of FIG. 1 may correspond to one or more devices having means (e.g., hardware and/or software) for performing the functionality described herein. For example, each AP 120 may include one or more devices capable of receiving, generating, storing, processing, providing, and/or routing information associated with positioning measurements, as described elsewhere herein. Thus, each AP 120 may comprise a communication device and/or a computing device. According to some embodiments, each AP 120 may be configured to transmit beacons (e.g., BLE beacons) and scan and locate other devices (e.g., other devices communicating using BLE protocols). Similarly, each wireless device 130 may comprise one or more devices capable of receiving, generating, storing, processing, and/or providing information associated with positioning measurements, as described elsewhere herein. Each wireless device 130 may therefore comprise a communication device and/or a computing device. As noted, a wireless device 130 may comprise an ESL radio, according to some embodiments. The ME 110 may comprise one or more devices capable of receiving, generating, storing, processing, providing, and/or routing information associated with positioning measurements, as described elsewhere herein. The ME 110 may comprise a communication device and/or a computing device. For example, the ME 110 may comprise a server, such as an application server, a client server, a web server, a database server, a host server, a proxy server, a virtual server (e.g., executing on computing hardware), or a server in a cloud computing system. In some aspects, the ME 110 comprises computing hardware used in a cloud computing environment. The APs 120 may be communicatively connected to the ME 110 via a network (not shown), such as the Internet.

As used herein, the terms “network entity” and “network device” may be interchangeable. For example, an AP can be referred to as an example of a “network entity” and/or can be referred to as an example of a “network device.” A “network entity” can include an AP, an ME, and/or a combination of the two. A “network device” can include an AP, an ME, and/or a combination of the two. In some examples, a single device can implement the functionality of an ME and an AP (e.g., an ME and an AP can be combined in a single device).

In various implementations, to facilitate control by the ME 110 (e.g., edge server), each peripheral device 140 (e.g., ESL) may have a wireless connection (e.g., via the wireless device 130 using a BLE connection or other connection) to an AP 120 that is communicatively connected to the ME 110 (e.g., via the Internet, such as wirelessly, via an Ethernet connection, etc.). In some cases, an AP 120 may wirelessly transmit commands from the ME 110 to the wireless devices 130 (e.g., ESL radios) and/or peripheral devices 140 (e.g., ESLs). Responses or information from the wireless devices 130 and/or peripheral devices 140 may also be received by the AP 120 and provided by the AP 120 to the ME 110.

In ESL systems, periodic advertisements (PAs) can be utilized to provide regular and predictable payload transmissions from an AP 120 to wireless devices 130. For example, PAs can be used to issue information from the ME 110 to the wireless devices 130 and/or peripheral devices 140, which may be within one or more groups of wireless devices 130. PAs are generally unidirectional (e.g., unidirectional transmissions) such that PAs are transmitted one-way from an AP 120 to the corresponding wireless devices 130.

As noted, Periodic Advertisement with Response (PAwR) can be used for ESL systems to provide bidirectionality. Wireless devices 130 synchronized within a group of wireless devices 130 can be addressed by an AP 120 on a synchronized channel (e.g., a radio frequency (RF) channel between the AP 120 and the wireless devices 130) whenever the AP 120 determines to send (e.g., transmit) a request to the wireless devices 130. In some cases, as used herein, a synchronized channel refers to a channel on which transmissions are synchronized (in time). For example, the channel can utilize or can be based on a frequency on which one or more communications are transmitted.

According to some embodiments of a system 100, peripheral devices 140 may comprise devices in addition or as an alternative to ESLs with which each wireless device 130 communicates. For example, according to some embodiments, peripheral devices 140 may comprise Internet of things (IoT) devices managed by the system 100, such as robotic equipment, sensors (temperature, light, gas, etc.), lights, or the like. Put differently, the system 100 may be capable of monitoring and/or controlling various systems via wireless devices 130, depending on desired functionality.

Target device(s) 160 may include various types of devices for which positioning can be determined by the system 100. For example, a target device 160 may comprise an “ambient” internet of things (IoT) device in the form of a low-cost, batteryless, energy harvesting tag, such as an electronic tag (eTag). As described herein, an eTag may be used by and/or incorporated into a target device or asset for which the system 100 may perform positioning. Wireless devices 130 may perform positioning of eTags and/or other target devices by performing measurements of wireless signals transmitted by the eTags. Thus, eTags can each be attached to assets located within one or more facilities (e.g., a retail store, a warehouse, etc.) within the coverage area of the system 100 for asset tracking, monitoring, and/or supply chain management purposes. Devices, such as devices for energizing (e.g., which may be referred to as “energizing devices,” “energizers,” or “readers”), can interrogate, scan, read, probe, and/or energize the eTags.

According to some embodiments, target devices 160 comprising ambient IoT devices such as eTags (e.g., being batteryless) may be powered by harvesting energy (e.g., power) from signals (e.g., energizing signals, RF signals, sweeping beams, or energizing waveforms) transmitted from the devices (such as energizing devices). After being energized, the ambient IoT devices can each transmit a response signal (e.g., a beacon) including some identifying information (e.g., metadata) that is unique to each ambient IoT device. Near field communication (NFC) tags can support communication as well. The ME 110 may store and maintain a database of information pertaining to the ambient IoT devices (e.g., information related to their capabilities and last known locations).

According to some embodiments, a wireless device 130 may be capable of positioning a target device 160 based on received signal strength indicator (RSSI) measurements of the one or more beacons 170 (or other RF signals) transmitted by the device. As previously noted, a target device 160 may comprise an ambient IoT device, such as in the form of an eTag. The position of the target device 160 may then be estimated based on a range (distance) between the target device 160 and one or more wireless devices 130, derived from the RSSI of measurements of the one or more wireless devices 130. The positioning may be determined geometrically based on known positions of the wireless device(s) 130.

It can be noted that, although embodiments primarily describe the use of RSSI measurements for the positioning of an eTag or other target device, embodiments are not so limited. RSSI measurements can be particularly useful for low-power applications, however, other types of positioning measurements may be used, including angle of arrival (AOA), round trip time (RTT), and/or other types of RF signal measurements used for the positioning of a mobile device, or any combination thereof.

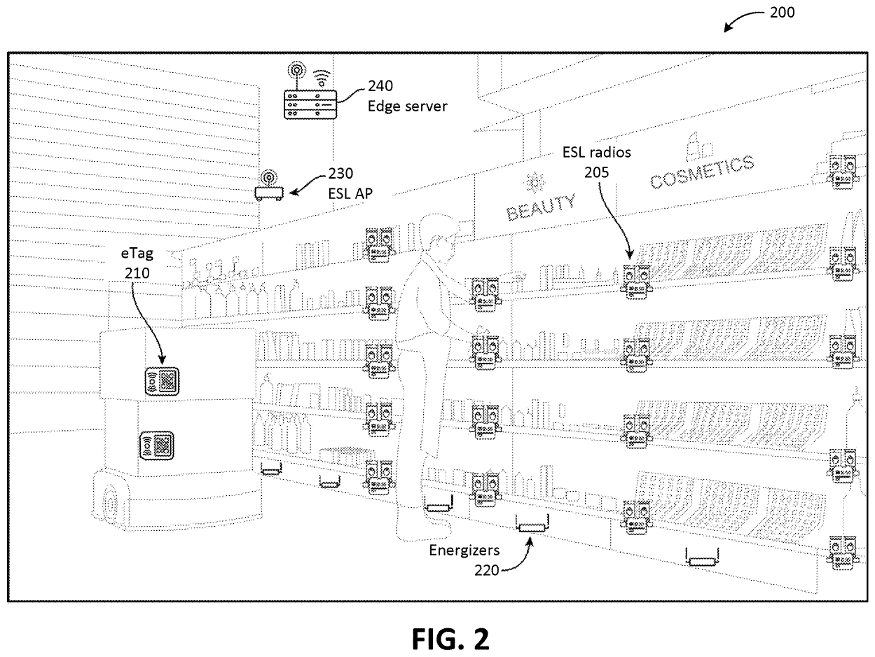

FIG. 2 is an illustration of an example ESL system 200 deployed within a retail store, according to an embodiment. The ESL system 200 may comprise a particular implementation of a wireless communication and positioning system 100, as previously noted. It can also be noted that an ESL system may not be limited to a retail environment, but additionally or alternatively may be deployed in commercial, industrial, or other environments (e.g., warehouses), in which such systems may be beneficial. The system 200 employs ESL radios 205 (corresponding to wireless devices 130 of FIG. 1) as anchor nodes for positioning of target devices (e.g., target devices 160), such as eTag 210 or other wireless mobile devices (e.g., mobile phones) (not shown). Additionally shown in FIG. 2 are energizers 220, an ESL AP 230 (e.g., corresponding with APs 120 of FIG. 1), edge server 240 (e.g., corresponding with ME 110, which may be located within the retail store). ESLs may be powered and controlled by an electronic rail mounted within shelving units, and each electronic rail may be associated with an ESL radio 205.

In one or more aspects, the energizers 220 (e.g., mounted on shelves and/or mobile devices, such as a smartphone, a robot, a forklift, etc.) may have one or more capabilities. In one or more examples, the energizer 220 may have a capability of supporting RFID technology, which may include the ability to read and scan an eTag 210 (e.g., RFID tag or other ambient IoT device), and include the ability to support communications using one or more frequency bands related to RFID technology, such as low frequency (LF), high frequency (HF), near field communication (NFC) frequency, and ultra-high frequency (UHF). In some examples, the energizers 220 may have an energizing capability, energizing an eTag 210 and (e.g., optionally) instructing the ambient eTag 210 to communicate (e.g., via a broadcast or a unicast) with another device (e.g., communicate information about a particular item to an access point, such as for inventory purposes). In one or more examples, the energizers 220 may have a capability to support beamforming (e.g., a beamforming capability to be able to form an antenna beam and scan, for example, steer the beam towards a particular eTag 210), such as for the purpose of interrogating the eTag 210.

In one or more aspects, during operation of the system 200 of FIG. 2 within a retail store scenario, the energizer 220 can send (e.g., transmit) energizer signals (e.g., energizer transmissions) to the ambient eTag 210. The eTag 210 can receive the energizer signals and harvest energy from the energizer signals to energize themselves. After the eTag 210 has harvested enough energy to be able to transmit, the eTag 210 (e.g., eTags) can send (e.g., transmit) beacons (e.g., beacon frames).

In one or more examples, the ESL radios 205 (e.g., radios of ESLs with known positions that can operate as anchor nodes), which are located within the vicinity of the eTag 210, can receive the beacons transmitted from the eTag 210. In some examples, ESL radios 205 receive the beacons and may obtain information from the beacons (e.g., information related to the eTag 210, such as unique identifying information, and/or information related to items or products associated with the eTag 210), and may obtain measurements (e.g., signal strength measurements, such as RSSI values) of the received beacons. In response to receiving the beacons, the ESL radios 205 may relay the information within and/or associated with (e.g., measurements, such as RSSI values) the beacons to the edge server 240 via ESL AP 230.

As previously noted, the system 200 of FIG. 2 additionally or alternatively may be configured to position a target device comprising a mobile device (e.g., a mobile phone, retail device, etc.) that may be associated with a user (e.g., a customer or employee), who may be walking down an aisle of the store. In one or more examples, during the operation of system 200 within a retail store scenario, ESL radios 205 located within the vicinity (e.g., a threshold distance) of the mobile device (e.g., with an unknown position), can send (e.g., transmit) beacons (e.g., beacon frames). The mobile device can then receive the beacons from the ESL radios 205. The mobile device may obtain information from the received beacons (e.g., information related to the ESL radios 205, such as unique identifying information) and/or may obtain measurements (e.g., signal strength measurements, such as RSSIs) of the received beacons. In one or more examples, the mobile device may utilize the information and/or the measurements to determine its position.

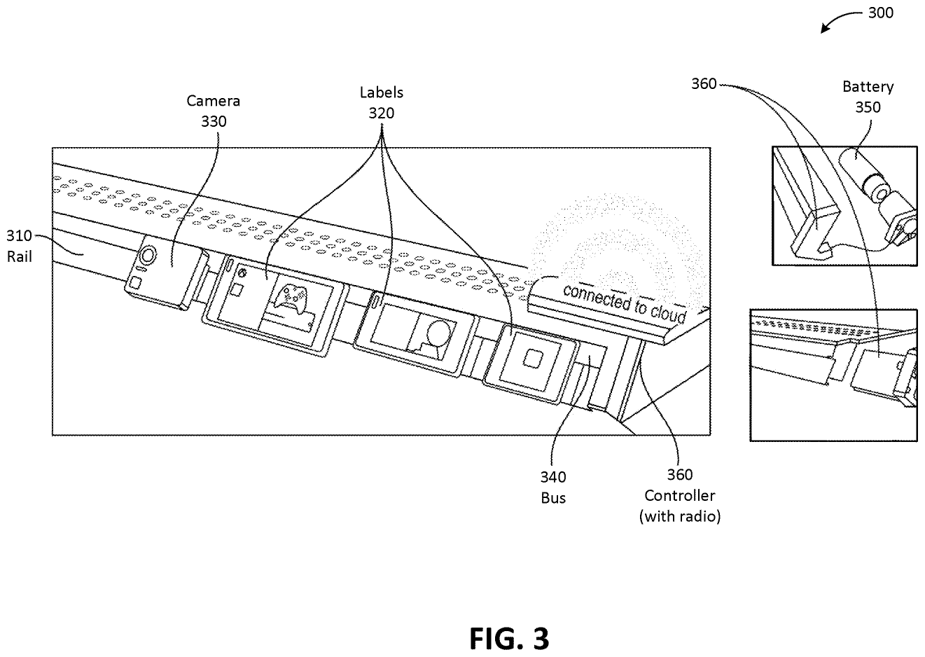

FIG. 3 is an illustration of various views 300 of an example wireless communication device rail 310, also referred to herein as an “ESL rail.” In one or more examples, the wireless communication device rail 310 may be installed along a shelf of a shelving unit within a store or a warehouse (e.g., in a retail environment, such as the example shown in FIG. 2). Alternative embodiments may include differently-configured components, which may be adapted to fit particular types of shelving.

The wireless communication device rail 310 is shown to include (e.g., implemented within the wireless communication device rail 310) three labels 320 (e.g., ESLs), although different embodiments may have a different number of labels 320 per rail 310. Each label 320 may include a display, such as a light emitting diode (LED) display or an electric-paper (e-paper) display. The wireless communication device rail 310 may also include a camera 330 (e.g., an image sensor), a bus 340, a battery 350 (e.g., used to power the wireless communication device rail 310), and a rail controller 360 as illustrated. The rail controller 360 may include an ESL radio, which may operate in the manner previously described (e.g., with respect to ESL radios 205 of FIG. 2 and/or wireless devices 130 of FIG. 1). The bus 340 may provide electrical power and/or communication to the various components of the wireless communication device rail 310. Additionally, or alternatively, as previously noted, labels 320 (and/or other devices) may communicate wirelessly with the controller 360. The controller 360 may receive information from a managing entity (e.g., ME 110 and/or edge server 240), via an AP (e.g., AP 120 of FIG. 1 and/or ESL AP 230 of FIG. 2), including information regarding what to display on each of the labels 320.

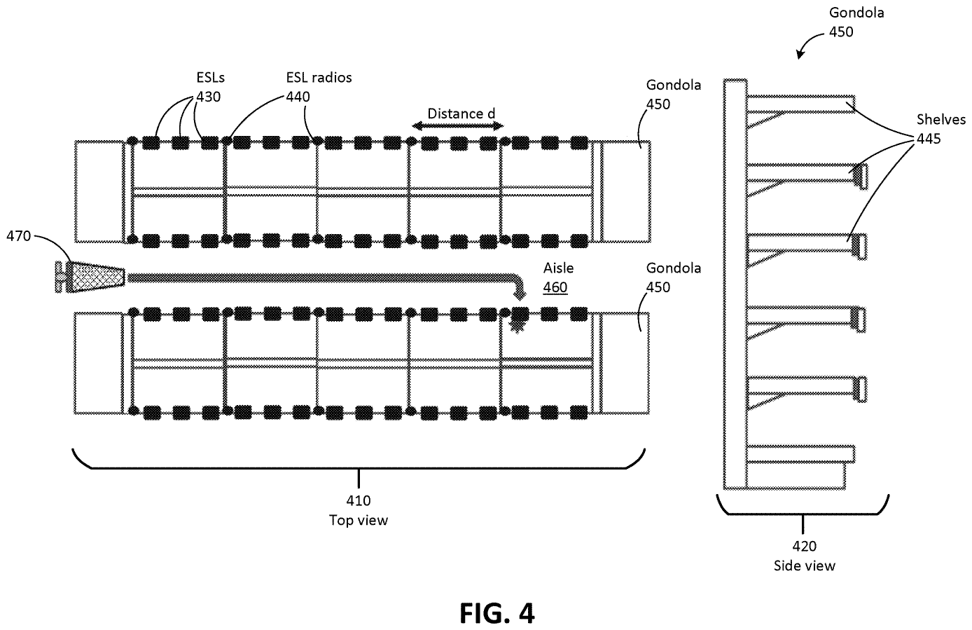

FIG. 4 is a diagram illustrating a top view 410 and side view 420 of an example configuration in which ESLs 430 and ESL radios 440 are installed on shelves 445 of a gondola 450 (e.g., shelving unit). (To avoid clutter, only a portion of the ESLs 430, ESL radios 440, and shelves 445 are labeled.) As shown in FIG. 3 and described above, ESLs 430 and ESL radios 440 may be incorporated into an ESL rail (e.g., rail 310) installed on a shelf 445, according to some embodiments. As illustrated in the top view 410, gondolas 450 may be disposed in parallel, separated by an aisle 460. Gondolas 450 may have any number of shelves, although 4-6 shelves are common. The ESLs 430 may be deployed in a dense manner, and ESL radios 440 may be deployed at a distance d apart from one another, where the value of d can vary depending on desired implementation. The value of d in some implementations may be between 1-2 m, for example, and some embodiments may fall outside this range. Although three ESLs 430 are associated with each ESL radio 440 in FIG. 4, the number of ESLs 430 associated with each ESL radio 440 may vary as previously noted, depending on desired functionality.

In some examples, the ESL radios 440 can be used as anchor nodes for positioning of target devices, including ambient IoT devices, such as eTags, as previously described. In one or more examples, a shopping cart 470 may include an eTag (or other target device) and may travel along the aisle 460. In some embodiments, the shopping cart 470 may include an energizing device (e.g., energizer 220 of FIG. 2) that can send (e.g., transmit) energizing signals to energize the eTag. Once receiving sufficient charge, the eTags can then transmit beacons which are then received by the ESL radios 440. As previously indicated, the ESL radios 440 may obtain information from the beacons (e.g., information related to the ambient IoT devices themselves and/or information related to items or product associated with the ambient IoT devices), and may obtain measurements (e.g., signal strength measurements, such as RSSI values) of the received beacons. The ESL radios 440 may relay the information within and/or associated with (e.g., measurements, such as the RSSI values) the beacons to an ME via an AP. The ME can then determine the location of the eTag based on signal strengths (e.g., RSSI values) of the beacons measured by the ESL radios 440. According to some embodiments, the ME can then perform one or more operations to guide a user of the cart 470 to a desired location, such as causing a light or display near the location to blink, communicating directions and/or other navigation information to a mobile device of the user, etc.

According to some embodiments, a Weighted Centroid Algorithm (WCA) may be used to determine the location of an eTag, which may be more robust than traditional trilateration/multilateration in the presence of attenuation and non-line of sight (NLOS) effects. That said, embodiments may use trilateration/multilateration and/or other positioning techniques in addition to or as an alternative to WCA.

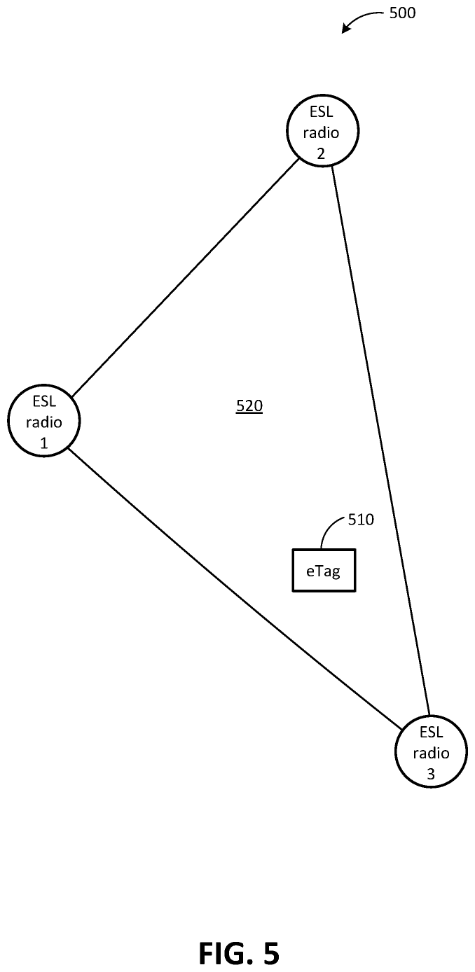

FIG. 5 is a diagram 500 of an example of position estimation of an eTag 510 using a WCA-based algorithm with measured RSSI values measured by ESL radios 1-3. In this example, the eTag 510 is located within a convex region formed by ESL radios 1-3.

The location of the eTag 510 within the convex region 520 may be determined as follows. For a given eTag transmission, r₁≥r₂≥ . . . r_{M} denotes the RSSI values for M number of ESL radios in descending order. The position estimate for the eTag can then be given by the weighted average of the known positions of the ESL radios (e.g., ESLs 1-3), where the weights may be a function of the RSSI values. The position of the eTag therefore may be determined by using the following equations:

$$\hat{P} = \frac{{\sum }_{k = 1}^{N} {w}_{k} \cdot {P}_{k}}{{\sum }_{k = 1}^{N} {w}_{k}} , and \qquad ( Eqn . 1 )$$

$${w}_{k} = {2}^{\frac{{r}_{k} - {r}_{1}}{λ}} , \qquad ( Eqn . 2 )$$

where N is the number of ESL radios (e.g., 3 in the diagram 500 of FIG. 5), wₖ is the respective weight for each ESL radio k, Pk is the respective known position (e.g., ground truth locations) for each ESL radio k, and A is a factor that determines a “priority level” for how the RSSI measurements are ranked and translated into weights. N is a subset of M. Both N and λ may be empirical terms, which may be preset to some desired value.

According to some embodiments (e.g., embodiments utilizing BLE), a generic attribute profile (GATT) protocol may be used to exchange data between devices. In particular, GATT may be used to organize data into a hierarchical structure in which data is structured into profiles, services, characteristics, and descriptors, and data is stored by a GATT server that allows GATT clients to access the data via requests. According to some embodiments, a BLE GATT server may be implemented by an ESL radio (or corresponding ESL controller), which can store information defined for eTag RSSI values measured by the ESL radio. This configuration can enable a bulk data read, allowing accumulation and less frequent reading of eTag scan results stored at an ESL radio. This can be useful, for example, if there are many active eTags. However, in such configurations, the overhead of Bluetooth asynchronous connection-oriented logical transport (ACL) connect/disconnect for every query can result in slower response time. According to some embodiments, GATT-based protocol may be used to relay information from ESL radios (e.g., reporting measured RSSI values for an eTag) to an ESL AP and/or ME.

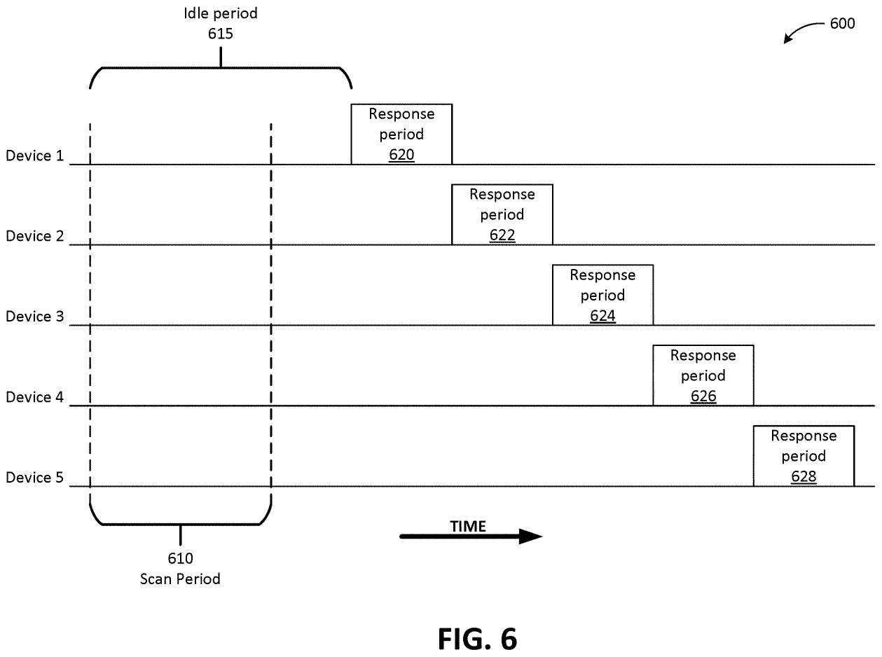

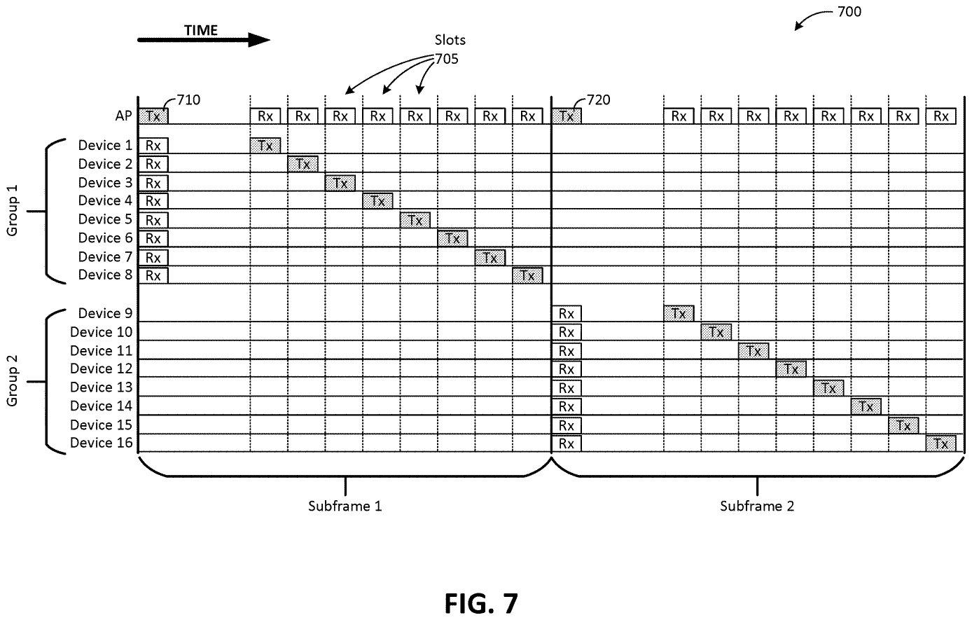

Additionally, or alternatively, embodiments may use Periodic Advertisement with Response (PAwR). PAwR was introduced to ESL systems to allow ESL radios to respond to PAs transmitted by ESL APs, enabling bidirectional communications between ESL radios and an ESL AP (and/or ME) rather than unidirectional communications from the ESL AP (and/or ME) to ESL radios. ESL radios within a group can be addressed by an ESL AP on a synchronized channel (e.g., a synchronized frequency channel between the ESL AP and the ESL radios) whenever the ESL AP determines to send (e.g., transmit) a request (e.g., a PA containing a synchronization message transmitted on the synchronized channel) to the ESL radios. If a response from an ESL radio is expected by the ESL AP (e.g., the synchronization message from the ESL AP requests a response from a specific ESL radio), the particular ESL radio will respond in a specific response slot based on where the ESL radio appeared within a sequence contained within the synchronization message transmitted by the ESL AP. PAwR can help facilitate low-power communications with relatively little overhead and response time. However, packet payload size can be limited (e.g., 48 bytes) so that only one eTag payload (e.g., 40 bytes) can fit into one slot. Additional details regarding the PAwR process that may be used in an ESL system are illustrated in FIGS. 6 and 7, discussed below.

FIG. 6 is a signaling diagram 600 of an example PAwR for a group of wireless devices, Device 1-5, illustrating a portion of a communication between an access point (e.g., AP 120, ESL AP 230) and wireless devices (e.g., wireless devices 130, ESL radios 205). With reference to FIG. 1, the signal sequence illustrated in FIG. 6 may be implemented by one or more of the communication connections between APs 120 and corresponding wireless devices 130. It will be understood that FIG. 6 is provided as a non-limiting example, and various aspects such as the precise timing, number of devices, etc., may vary in different embodiments and implementations.

Devices 1-5 of FIG. 6 may be selected from wireless devices as noted above (e.g., grouped in a manner described hereafter), and may receive a PA in a scan period 610. The scan period 610 may occur in regularly scheduled intervals and may be repeated periodically such that Devices 1-5 can awaken to scan for messages during this repeated scan period 610. An AP may provide periodic advertisements (PAs) via broadcast or multi-cast to Devices 1-5 in the scan period 610. For an AP, the scan period 610 can be its primary transmission period. In some cases, the scan period 610 may not be a fixed time because the AP may send different lengths of data from the start of the scan period 610.

The transmission may include multiple advertisements in a train. One or more portions of the advertisements may be directed to one or more of Devices 1-5. Each of Devices 1-5 may decode or filter the messages intended for each specific device and transmitted during the period when all devices are receiving. In this way, each device may be reprogrammed, updated, and/or sent requests from an AP or relayed from another device (e.g., an ME) via the AP. The periodic advertisement (PA) from the AP may set a response period for one or more of the Devices 1-5.

As illustrated, each device assigned a response period 620, 622, 624, 626, 628 in the time after the scan period 610. The response periods 620, 622, 624, 626, 628 can occur in a time division multiple access (TDMA) manner. In some cases, the assignment of the response period to a particular device may not be permanent. In some aspects, the assignment may be inferred from a payload of a synchronization message. The first response period 620 may begin following an idle time 615 after the scan period 610, with the idle period being long enough to provide the transmitter device an opportunity perform related operations (e.g., perform measurements of beacons from eTags). The assigned response periods may also be limited to or designate a particular frequency of the channels on which to respond. For example, in FIG. 6, Device 1 is assigned response period 620, Device 2 is assigned response period 622, Device 3 is assigned response period 624, Device 4 is assigned response period 626, and Device 5 is assigned response period 628. The AP may store attributes of Devices 1-5, including whether a device is able to transmit or respond. The PA signaling followed by responses may be referred to as periodic advertisement with multiple responses (PAwMR).

For example, Device 3 may comprise an ESL radio and may receive a price update in a PA from the AP (an ESL AP) during scan period 610. The PA received at Device 3 may include a designated start time for the response period 624 or may include a schedule of response start times for devices including Device 3. The response by Device 3 to the AP may include an acknowledgement, a status code, and/or other information such as battery life, received signal strength, and/or an error notification. The response by Device 3 may include information (e.g., RSSI values of one or more eTags) to be relayed to another device (e.g., an ME) by the AP. The response may include a packet with a header and may conform to any applicable protocol(s) (e.g., BLE protocols). A response may be transmitted in a data channel of the applicable protocol(s) to the AP. Both the PA and the responses from Devices 1-5 may use channels of the applicable protocol(s).

A device (e.g., Devices 5) that has been assigned a response period may not respond and may determine that it has nothing to signal. In other words, the devices may determine what response, if any, is required and may or may not respond to a request sent from the AP. The response periods 620, 622, 624, 626, 628 may be assigned based on a request for such a period in an open transmission time (not shown), the request being sent to the AP. The response periods 620, 622, 624, 626, 628 may be assigned based on which devices have been requested by the AP to send data or acknowledgements. The PA messages and responses may be frequency-hopped, time-synchronized channels, and/or extended channels of the advertisement channels (e.g., in BLE).

FIG. 7 is an example signaling diagram 700 that shows the transmission (Tx) and reception (Rx) of communication packets in accordance PAwR protocol for an AP and two groups (Group 1 and Group 2) of wireless devices (Devices 1-8 and Devices 9-16) corresponding to the AP. Different groups may have different group IDs, and communication (e.g., APs) to a specific group may include the group ID of the group. Again, devices may comprise ESL radios, as described elsewhere herein. With reference to FIG. 1, the signal sequence illustrated in FIG. 7 may be implemented by one or more of the communication connections between APs 120 and corresponding wireless devices 130. It will be understood that FIG. 7 is provided as a non-limiting example, and various aspects, such as the precise timing, number of devices, etc., may vary in different embodiments and implementations. Moreover, wireless devices may be grouped (e.g., by the AP or an ME) in accordance with various characteristics and may have different numbers of devices (e.g., one group may be larger or smaller than another). In some implementations, a device may be part of multiple groups. As illustrated, the horizontal axis of the signaling diagram 700 of FIG. 7 denotes time, which is divided into two sequential subframes (Subframes 1 and 2), each having multiple slots 705. (To avoid clutter, only a few slots in FIG. 7 are labeled.) In one or more examples, there may be greater or fewer than two subframes as is shown in FIG. 7. Moreover, in some embodiments, subframe sizes may be dependent on group sizes.

In signaling diagram 700, during operation for PAwR, the AP transmits a first PA 710 to Devices 1-8 comprising Group 1. As previously noted, the first PA 710 may contain a synchronization message (e.g., an AP synchronization message) over a synchronized channel between the AP and the Devices 1-16. As noted previously, a synchronization message can include one or more commands. For instance, a command can include an operational code (OpCode) and parameters associated with the command. As further illustrated in FIG. 7, each of the devices in Group 1 (Devices 1-8) can receive the first PA 710. Further, each of the devices in Group 1 (Devices 1-8) may respond to the first PA 710 by using their specific respective response slot 705. As further illustrated in FIG. 7, the process of Subframe 1 with respect to Group 1 can repeat in Subframe 2 with respect to Group 2, initiated by the transmission of a second PA 720.

As noted, PAWR schemes such as those illustrated in FIG. 7 can be limited in the amount of data that can be reported to the AP from each device. This can pose problems for devices that need to report more information. For instance, if data corresponding to a single eTag's information (e.g., measured RSSI value) is 40 bytes, a device comprising an ESL radio may be only able to report information (e.g., measured RSSI values) for one eTag during its corresponding response slot 705. Thus, if the device has information regarding multiple eTags (or a large amount of information regarding one eTag) it may not be able to provide a full report of the eTag(s) during its response slot 705.

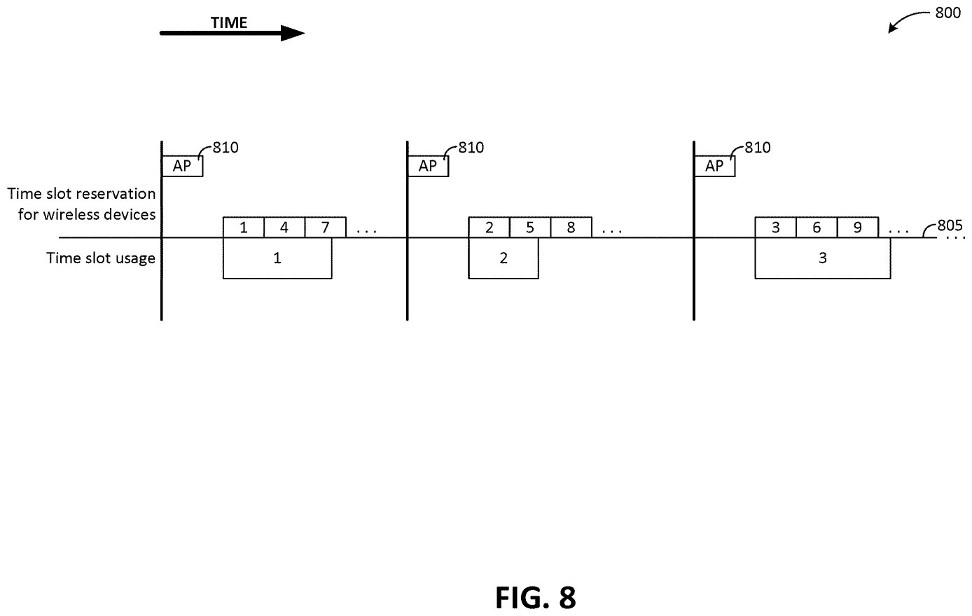

Embodiments address these and other issues by implementing grouping and/or filtering strategies for wireless devices (e.g., ESL radios). For example, a grouping strategy that may be utilized by a network device (e.g., an AP or ME) based on one or more criteria across wireless devices (e.g., ESL radios) associated with the network device. The grouping strategy may be determined such that multiple time slots may be allocated to a single wireless device within a subframe, while other wireless devices within the group remain idle and may not be addressed by the AP. By providing multiple slots to a single wireless device, the wireless device can transmit larger amounts of data (e.g., measurement data) corresponding to one or more eTags. An example of this is illustrated in FIG. 8, described below.

FIG. 8 is a diagram 800 illustrating how embodiments may utilize a new transmission (Tx) scheme, according to some embodiments. In this diagram 800, a timeline 805 is shown, above which is shown a “time slot reservation for wireless devices” showing the numbers of devices in a group of devices for which slots are reserved for transmitting data packets to the AP, similar to the methods illustrated in FIGS. 6 and 7. In this example, devices associated with an AP are numbered 1-9. The “time slot usage” shows an example of how devices 1-3 may use longer transmission times that would extend into the slots that would otherwise be reserved for other devices. According to some embodiments, the time slot reservation for wireless devices may be used for traditional communications between an AP and a group of wireless devices, and the longer transmission times shown in “time slot usage” in FIG. 8 and described herein may be used when needed (e.g., when positioning measurements are to be reported by spatially proximate wireless devices in different groups). As such, an AP and a group of corresponding wireless devices can toggle between traditional and time slot usages as needed. (According to some embodiments, the need to toggle from one Tx scheme to the other may be based on information communicated prior to toggling Tx schemes. For example, while communicating in accordance with a traditional time slot reservation scheme, one or more wireless devices may communicate to the AP that additional reporting is needed (e.g., positioning information regarding one or more eTags needs to be reported). The AP can then coordinate operation in the time slot usage to allow for the reporting of the positioning information.) Further, devices associated with an AP may be divided into different groups for purposes of reporting via the modified Tx scheme based on one or more criteria.

For example, one such criterion may comprise spatial grouping based on known locations of the wireless devices. For example, consider three sets of wireless devices comprising ESL radios numbered 1-9 deployed in a retail store having multiple aisles, where each set of ESL radios is as follows: {1,2,3}, {4,5,6}, {7,8,9}. Each of these sets of ESL radios may be determined based on their location within a certain area (for instance, in the same aisle). However, each set is spatially separated from one another. For example, Set 1 {1,2,3} may be located in Aisle 1, Set 2 {4,5,6} in Aisle 7, and Set 3 {7,8,9} in Aisle 15. Groups may then be formed so that spatially separated devices from different sets are grouped together and share a subframe in a PAwR scheme. For example, Group 1 could be devices {1,4,7}, Group 2 could be devices {2,5,8}, Group 3 could be devices {3,6,9}.

Grouping spatially separated wireless devices in this manner allows an ESL radio that may have positioning information (e.g., measured RSSI values) of a nearby eTag (other target device) to report using one or more slots of other ESL radios in its group. This is because the other ESL radios in the group are spatially separated and, therefore, may not have detected the eTag and may not have anything to report. For instance, in the example above, a target device in Aisle 1, the spatial grouping of ESL radios allows Set 1 {1,2,3} to encroach upon additional slots that otherwise would be reserved for radios in their respective groups that are in other (spatially separated) sets. Thus, the target device's position may be estimated with higher accuracy, given that more information can be sent over multiple slots (as opposed to a single slot). In the diagram 800 of FIG. 8, for example, ESL radios 1, 2, and 3 are in three different groups that report in three different subframes. ESL radios 1, 2, and 3 report information using multiple slots in the subframes of their respective groups, extending beyond a single slot that would otherwise be reserved for those radios: ESL radio 1 uses slots reserved for ESL radios 4 and 7; ESL radio 2 uses slot reserved for ESL radio 5; and ESL radio 3 uses slots reserved for ESL radios 6, 9, and a subsequent slot (not shown). This time slot usage may result when ESL radios are configured to report positioning data using larger packets (regardless of whether it extends beyond one slot) which may be a preconfigured functionality or be part of a modified reporting scheme transmitted to the various ESL radios by the AP via PAs 810. It can be noted that, although multiple subframes (corresponding to each PA) are illustrated, a time slot usage that extends the slots of certain ESL radios in the manner illustrated may be performed over a single subframe (e.g., in which spatially-separated ESL radios are given adjacent slots) or a different number of subframes than illustrated in FIG. 8.

Depending on desired functionality, interference management could be conducted in different ways. For example, in the example of a group of ESL radios comprising spatially separated ESL radios, it may be unlikely that more than one ESL radio in the group would need to report positioning information of eTags during the same subframe. As such, if devices are configured to transmit packets only when they have positioning information to report (at least one operating in the time slot usage to report positioning information), then interference may be unlikely. In such instances (e.g., in environments having a relatively low density of eTags), an AP may not need to perform active interference management. In some embodiments, however, the AP may play a more active role and may indicate (e.g., in a PA) which ESL radios should (and/or should not) transmit reporting information during which slots of a subframe. Additionally, or alternatively, embodiments may use different channels within a group of ESL radios to help reduce the likelihood of interference. For instance, in the previous example, in which Group 1 comprises devices {1,4,7}, Group 2 comprises devices {2,5,8}, and Group 3 comprises {3,6,9}, different advertising channels could be used within each group. For Bluetooth® advertising channels 37, 38, and 39, devices {1,2,3} may use channel 37, devices {4,5,6} may use channel 38, and devices {7,8,9} may use channel 39. In such embodiments, an AP may need to support multiple-channel reception. However, many APs have such capabilities.

Depending on desired functionality, the grouping of wireless devices (e.g., ESL radios) based on spatial separation for purposes of reporting information (e.g., measured RSSI values and/or other positioning information) may be performed in different ways. For example, according to some embodiments, grouping may be performed based on a distance value (e.g., grouping ESL radios having a threshold distance from one another, where the threshold value is 10 m, 15 m, 20 m, etc., which may be determined based on desired functionality). Additionally or alternatively, grouping may be performed based on one or more physical features of the environment in which wireless devices are employed (e.g., aisle-level information, where ESL radios within groups are separated by at least one aisle). Physical features of the environment additionally or alternatively may include section-level information (e.g., ESL radios are grouped based on different sections of a retail store, such as produce, cosmetics, pharmacy, etc.).

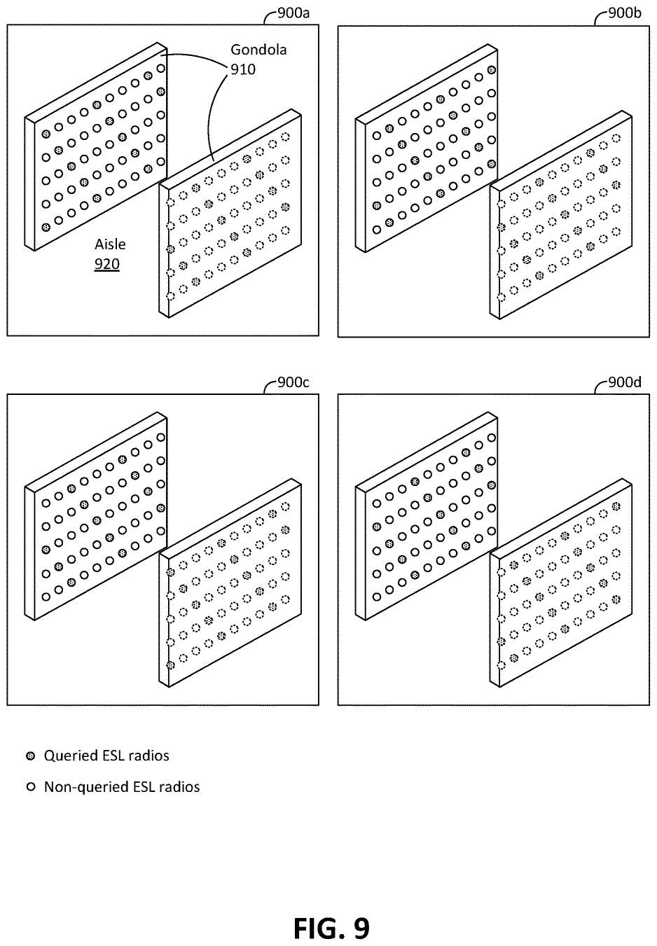

When initially querying a group of wireless devices for reporting information, an AP may not need to query all devices in a group. For ESL radios installed on gondolas on either side of an aisle, for example, there may not be a need to query all ESL radios if no eTag has been detected in the aisle. As such, according to some embodiments, different techniques may be used for creating an initial query list (a list of ESL radios to query when no eTag has been detected) to effectively downsample the total number of ESL radios queried, which can save wireless and battery resources within an ESL system. Further, once an eTag has been detected, embodiments may utilize different techniques for creating an updated query list to again save wireless and battery resources while efficiently performing eTag positioning. A query list, which may be determined by an ME, may include a list of ESL radios, described by the ESL identifier (Eid) of each ESL radio to be queried by the ESL AP. The query list may also comprise a maximum allowable duration for transmission for each ESL radio, which may be described in unit of time slots or other time duration (e.g., microseconds). Techniques for creating initial and updated query lists are described below, with respect to FIG. 9.

FIG. 9 is a sequence of illustrations 900a, 900b, 900c, and 900d, providing an example of how different clusters of ESL radios may be queried at different times, according to an embodiment. As shown with the labels in illustration 900a, each illustration includes a pair of gondolas 910 on either side of aisle 920, where each gondola includes a large number of ESL radios (illustrated as circles) mounted thereon. Each illustration represents the same gondolas 910 and aisle 920 at different moments in time, in sequence from 900a to 900d. As illustrated via shading of the circles representing the ESL radios, different “clusters” of ESL radios are queried (e.g., by an ESL AP) at different times, which can help maximize eTag detection by an ESL system. As previously indicated, an initial query list can be used to perform queries of ESL radios prior to the detection of an eTag in a way that may help maximize eTag detection while also helping minimize wireless overhead and/or battery consumption.

According to some embodiments, an initial query list may be determined (e.g., by an ME) based on one or more approaches. A first approach, for example, comprises spatial interleaving in which ESL radios with uniform (or substantially uniform) spatial distance may be addressed every cycle or frame of the plurality of frames. An example of this is illustrated in the series of illustrations of FIG. 9. Another approach comprises temporal interleaving in which certain ESL radios may be queried more often by the ESL AP than others. For instance, because ESL radios located on the 2nd and 3rd shelves of a gondola are more likely to detect eTags may be queried more frequently (e.g., with higher periodicity) than ESL radios on the bottom and top shelves. Another approach may be based on battery life, in which ESL radios with higher battery resources may be queried more often, and ESL radios with lower battery resources may be queried less often, or not at all.

Once an eTag (or other target device) has been detected, an updated query list may be determined for subsequent queries of ESL radios. The updated query list can be based on one or more of the following criteria. According to some embodiments, for example, distance may be a criterion such that ESL radios that lie within a threshold distance of the most recent position estimates of an eTag/target device may be selected for subsequent querying. Additionally or alternatively, priority of a detected eTag/target device may be considered, such ESL radios reporting location information of a first eTag with more critical data (higher priority) may be allocated more duration for transmission and/or queried more often than ESL radios reporting location information of other eTags with less critical data (lower priority). Some embodiments may include cyclic reporting, in which the allowable duration for transmission per ESL radio may be cyclically increased or decreased every other frame (for instance, a particular eTag may be prioritized every alternate frame). Updated query lists additionally or alternatively may be based on positioning accuracy. That is, if a detected eTag/target device had poor accuracy (e.g., below a certain threshold) with high uncertainty, then a larger number of ESL radios with higher transmission duration may be queried in the subsequent frame to improve accuracy.

According to some embodiments, an updated query list may take into account a receiving (Rx) scanning pattern and/or pending amount of data to be sent. For example, an ESL radio may have indicated in a previous ESL data message that it has a large amount of pending data to be sent. Such pending data may include measurements that were acquired earlier at the ESL radio, but could not be reported due to insufficient time resources in a past communication opportunity. An updated query list may then allow increased transmission time to transmit the pending data. Additionally, or alternatively, an ESL radio associated with a higher scanning periodicity (Rx mode for detecting/measuring eTag beacons) may be assigned a larger transmission time in an updated query list, in anticipation of larger payload sizes for the upcoming ESL data message/report).

According to some embodiments, the querying of each ESL radio by an ESL AP may be made through an “ESL payload” element of its AP synchronization beacon message (e.g., PA). More specifically, the Len Cmd Value (LCV) of the ESL payload may contain an ESL command (Cmd element), which may be vendor-specific (an opcode of 0x_F, wherein {Len, Cmd} define a unique opcode). According to some embodiments, this vendor-specific portion may be utilized to define operations proposed herein such as querying eTag data (e.g. “Report eTag data”) and setting a maximum reporting duration (e.g. “Maximum duration of 2 time slots”), thereby enabling various functions described herein to be performed without any impact on the relevant Bluetooth® specification. According to some embodiments, the first octet or byte of the “Parameters” element may refer to the Eid of an ESL radio, which enables the ESL radio to determine whether the corresponding Cmd element is intended for it.

According to some embodiments, a command may be sent to an ESL radio by an ESL AP (e.g., via the vendor-specific portion described above) to indicate to the ESL radio to perform filtering of measurements prior to reporting them. This can help reduce the overhead while still receiving the most relevant information at the ESL AP.

Filtering may be performed based on one or more criteria, depending on desired functionality. According to some embodiments, for example, filtering may be performed by the age of measurement, such that only the most recent measurement information (e.g., most recent X number of measurements), or measurement information obtained within a recent period of time (e.g., within X seconds, minutes, etc.) is reported. Additionally or alternatively, filtering may be performed based on the type of measurement (e.g., only RSSI measurement values, AOA measurement values, etc. are reported). The value of the measurement also may be used for filtering. For example, measurements that exceed a threshold value (e.g. RSSI>=−65 dBm) may be reported, which can help ensure the quality of measurements reported. Additionally or alternatively, an uncertainty metric may be used for filtering measurement data, such that a measurement with the lowest uncertainty metric (or an uncertainty metric below a threshold) may be reported. According to some embodiments, statistics may be used, which can help decrease overhead while maintaining the quality of reported data. For example, a statistic such as the mean/median/standard deviation of a set of measurement values (e.g., measured RSSI values) may be reported. According to some embodiments, the type of target device possibly be used as a filtering criterion. The type of target device may be inferred, for example, through the device's MAC ID. An eTag MAC ID may be stored and known to an ESL radio, or through the device's payload. Smartphone/eTag traffic may be identified through control bits or application-layer information. According to some embodiments, any combination of the above criteria may be used. As an example, an average (statistics) of the two most recent RSSI measurements (age of measurement) from an eTag may be reported

It can be noted that, according to some embodiments, the LCV command may be represented in the form of a bitmap within the parameters element, wherein each unique bitmap corresponds to a type of filtering. Accordingly, an ESL AP can send a command to a receiving ESL radio to perform one or more types of filtering based on the bits of the bitmap.

Additionally, or alternatively, commands provided by an ESL AP may also refer to ESL radio scanning duty cycle information (Rx mode operation for acquiring eTag data). More specifically, a command provided by an ESL AP may comprise a list of slot indices pertaining to each ESL radio. According to some embodiments, this may also be embedded in the parameters element.

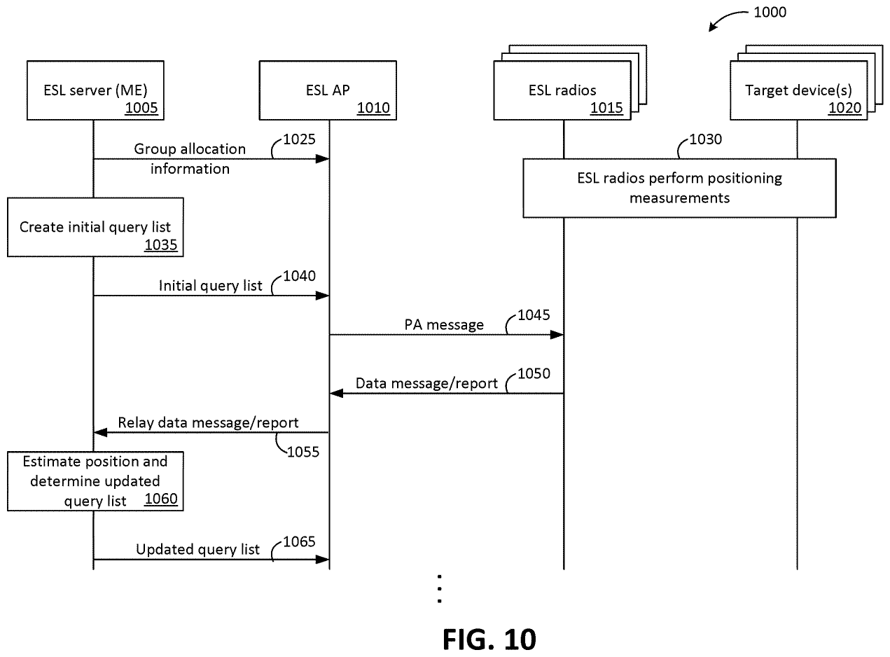

FIG. 10 is a message flow diagram 1000 illustrating a PAwR-based process of obtaining positioning measurements performed by one or more wireless devices, according to an embodiment. The various components illustrated in FIG. 10 include an ESL server (ME) 1005, ESL AP 1010, ESL radios 1015, and one or more target devices 1020. Aspects of the flow diagram 1000 may correspond with the embodiments described above. Moreover, according to some embodiments, the flow diagram 1000 may be implemented in non-ESL systems, including more generic components, as illustrated in FIG. 1.

The process may begin with the functionality shown by arrow 1025, for example, in which the ESL server 1005 provided group allocation information to the ESL AP 1010. As described above with respect to FIGS. 8, for example, this group allocation information may define groups of the ESL radios 1015, grouped to facilitate the reporting of positioning information regarding the one or more target devices 1020. These groups may be defined based on spatial separation across the ESL radios 1015 within a group. As noted in the embodiments described herein, the spatial separation may be based on a distance value, aisle-level information (e.g., of a retail or warehouse environment in which ESL radios 1015 are deployed), section-level information (e.g., of a retail or warehouse environment in which ESL radios 1015 are deployed), or any combination thereof.

The functionality at block 1030 comprises the ESL radios 1015 performing positioning measurements of the one or more target devices 1020. As illustrated in FIG. 10, this may be performed in parallel with communications between the ESL server 1005 and ESL AP 1010, prior to the ESL radios 1015 receiving a PA message from the ESL AP 1010. As described in the embodiments above, positioning measurements may be obtained by ESL radios 1015, which perform scanning to detect and measure RF beacons transmitted by the one or more target devices 1020. The positioning measurements may include RSSI, RTT, AOA, and/or other measurements made to determine the location of the one or more target devices 1020. Moreover, ESL radios 1015 may store positioning information, including the measurements made and information included in the RF beacons transmitted by the one or more target devices 1020 (e.g., ID information of the one or more target devices 1020), for subsequent reporting.

At block 1035, the ESL server 1005 creates an initial query list, which it then sends to the ESL AP 1010, as indicated by arrow 1040. This initial query list may be based on one or more approaches, including spatial interleaving, temporal interleaving, and/or remaining battery life, as described in the embodiments above. As also noted, the query list may comprise a list of ESL radios (e.g., identified by Eid) to be queried by the ESL AP 1010, and a maximum allowable duration for transmission for each radio.

As shown by arrow 1045, the ESL AP 1010 may then send a PA message (or other trigger message) to the ESL radios 1015, prompting the ESL radios 1015 to reply with data messages/reports, as shown by arrow 1050. The process illustrated by arrows 1045 and 1050 may reflect the PAwR processes described above with respect to FIGS. 6 and 7. Here, however, the ESL AP 1010 may enable a time slot usage in which certain ESL radios 1015 (e.g., as defined in the group allocation information provided at arrow 1025) may be allocated additional slots to transmit data messages/reporting (e.g., the stored positioning information), as described above with respect to FIG. 8. According to some embodiments, if no positioning information is reported, the process illustrated by arrows 1045 and 1050 may be repeated based on the initial query list (e.g., using spatial interleaving as shown in FIG. 9).

As shown by arrow 1055, the ESL AP 1010 may then relay the data message/reporting receiving the ESL radios 1015 to the ESL server 1005. Using this information, the ESL server 1005 may then estimate the position of each of the one or more target devices 1020, and may further determine an updated query list, as indicated by block 1060. As discussed in the embodiments above, the updated query list may take into account various factors for determining how to query the ESL radios 1015 in a way that can help ensure efficient and accurate positioning of the one or more target devices 1020. As noted in the embodiments described above, this may include querying ESL radios within a threshold distance of target device position estimates, target device prioritization, cyclically increasing/decreasing transmission duration of ESL radios, position accuracy, Rx scanning pattern and/or pending amounts of data to be sent by ESL radios 1015, or any combination thereof.

The ESL server 1005 can then send the updated query list to the ESL AP 1010, as indicated by arrow 1065, and the process may continue with subsequent queries (not shown) of the ESL radios 1015 in accordance with the updated query list.

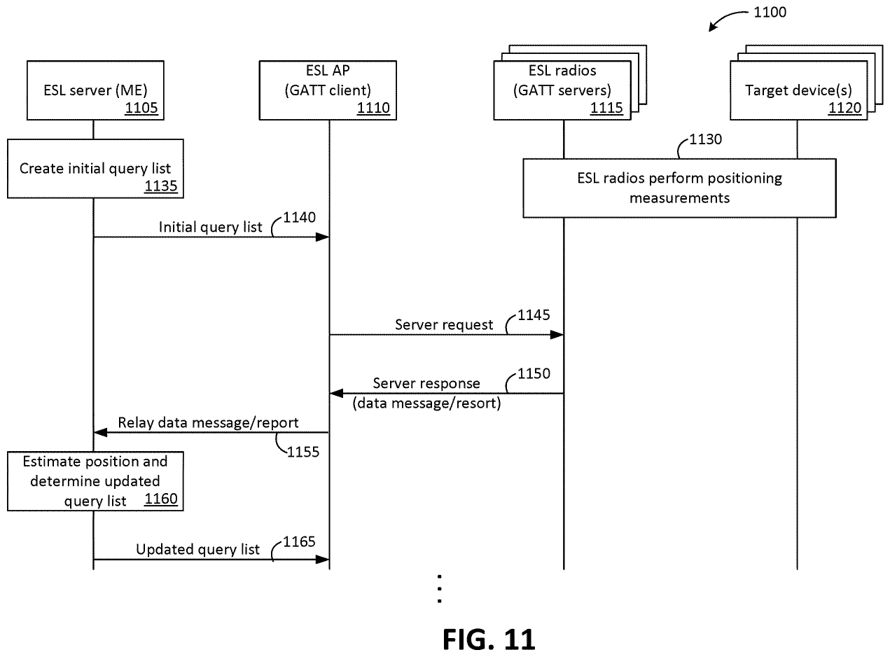

FIG. 11 is a message flow diagram 1100 illustrating a connection-oriented GATT protocol-based process of obtaining positioning measurements performed by one or more wireless devices, according to an embodiment. Similar to FIG. 10, the various components illustrated in FIG. 11 include an ESL server (ME) 1105, ESL AP 1110, ESL radios 1115, and one or more target devices 1120. Further, aspects of the flow diagram 1100 may correspond with the embodiments described above. Moreover, according to some embodiments, the flow diagram 1100 may be implemented in non-ESL systems, including more generic components, as illustrated in FIG. 1.

As can be seen, the GATT-based process may generally follow the PAwR-based process of FIG. 10, with a few exceptions. First, because reporting may not be slot based, group allocation information may not be needed in the GATT-based process of diagram 1100 and is therefore omitted. Further, the server request and server response shown by arrows 1145 and 1150, respectively, represent a GATT-based exchange between the ESL AP 1110 (operating as a GATT client) and the ESL radios 1115 (operating as GATT servers). More specifically, the server request at arrow 1145 may comprise a query to each ESL radio 1115 in a sequential manner, in order of the initial query list. Further, the server request may also include in the ESL command for each ESL radio. The server response at arrow 1150 may comprise a response in which each ESL radio 1115 reports eTag data (e.g., positioning information for each eTag) in accordance with the corresponding ESL command. Other operations illustrated in the GATT-based process of diagram 1100 may be performed in a manner similar to corresponding operations of diagram 1000 illustrated in FIG. 10, described above.

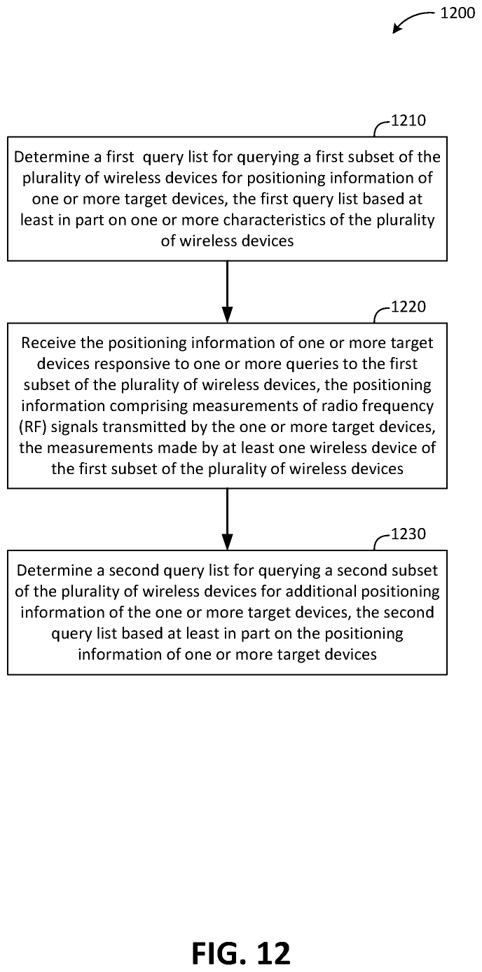

FIG. 12 is a flow diagram of a method 1200 of coordinating communication from a plurality of wireless devices, according to an embodiment. The functionality of some or all of the blocks in FIG. 12 may be performed by an ME, for example. That said, other entities (e.g., an AP) may be able to perform some or all of the functions. The wireless devices may comprise ESL radios, in some embodiments. Means for performing the functionality illustrated in one or more of the blocks shown in FIG. 12 may be performed by hardware and/or software components of a computing device. Example components of such a device are illustrated in 13, which is described in more detail below.

At block 1210, the functionality comprises determining a first query list for querying a first subset of the plurality of wireless devices for positioning information of one or more target devices, the first query list based at least in part on one or more characteristics of the plurality of wireless devices. This functionality may correspond, for example, to block 1035 of FIG. 10 and/or block 1135 of FIG. 11, discussed herein. Means for performing functionality at block 1210 may comprise at least one processor 1310, memory 1315, storage component 1320, and/or other components of a device 1300, as illustrated in 13.

At block 1220, the functionality comprises receiving the positioning information of one or more target devices responsive to one or more queries to the first subset of the plurality of wireless devices, the positioning information comprising measurements of radio frequency (RF) signals transmitted by the one or more target devices, the measurements made by at least one wireless device of the first subset of the plurality of wireless devices. This functionality may correspond, for example, to arrow 1055 of FIG. 10 and/or arrow 1155 of FIG. 11, discussed herein. Means for performing functionality at block 1220 may comprise, for example, at least one processor 1310, memory 1315, storage component 1320, output component 1330, communication component 1335, and/or other components of a device 1300, as illustrated in 13.

At block 1230, the functionality comprises determining a second query list for querying a second subset of the plurality of wireless devices for additional positioning information of the one or more target devices, the second query list based at least in part on the positioning information of one or more target devices. This functionality may correspond, for example, to block 1060 of FIG. 10 and/or block 1160 of FIG. 11, discussed herein. Means for performing functionality at block 1230 may comprise, for example, at least one processor 1310, memory 1315, storage component 1320, and/or other components of a device 1300, as illustrated in 13.

As noted in the embodiments discussed above, embodiments may include one or more features, for example. In some embodiments, the first query list may comprise, for each wireless device of the first subset of the plurality of wireless devices: an identifier of the respective wireless device, and a maximum allowable duration for transmitting a query response. The one or more characteristics of the plurality of wireless devices may comprise a location, a battery level, or both. In some embodiments, the second query is based at least in part on: a distance of each wireless device of the second subset of the plurality of wireless devices from the one or more target devices, a priority associated with the one or more target devices, an allowable duration of each wireless device of the second subset of the plurality of wireless devices for transmitting a query response, an accuracy for positioning the one or more target devices, an amount of data of each wireless device of the second subset of the plurality of wireless devices to report, an Rx scanning pattern of each wireless device of the second subset of the plurality of wireless devices, or any combination thereof. Some embodiments of the method 1200 may further comprise sending the first query list to one or more access points (APs) prior to receiving the positioning information; receiving the positioning information from the one or more APs; and sending the second query list to the one or more APs.

As discussed herein, spatial grouping of wireless devices may be performed, according to some embodiments. Thus, some embodiments of the method 1200 may further comprise determining a group allocation for the plurality of wireless devices, wherein the group allocation: divides the plurality of wireless devices into spatially separated groups based on known locations of the plurality of wireless devices; and enables each of one or more wireless devices of a first group to use multiple time slots of a periodic advertising with responses (PAwR) protocol for transmitting a query response. Such embodiments may further comprise sending the group allocation to one or more APs prior to determining the query list. Additionally, or alternatively, the group allocation may be based on a distance value between the groups, information regarding an environment in which the plurality of wireless devices is located, or both.

Some embodiments of the method 1200 may include one or more additional features, depending on desired functionality. For example, in some embodiments, measurements made by the at least one wireless device may comprise a portion of a larger set of measurements performed by the at least one wireless device, the portion obtained by filtering the larger set of measurements. In some embodiments, filtering of the larger set of measurements may be based at least in part on: measurement age, measurement type, measurement value, an uncertainty metric, measurement statistics, a target device type, or any combination thereof.

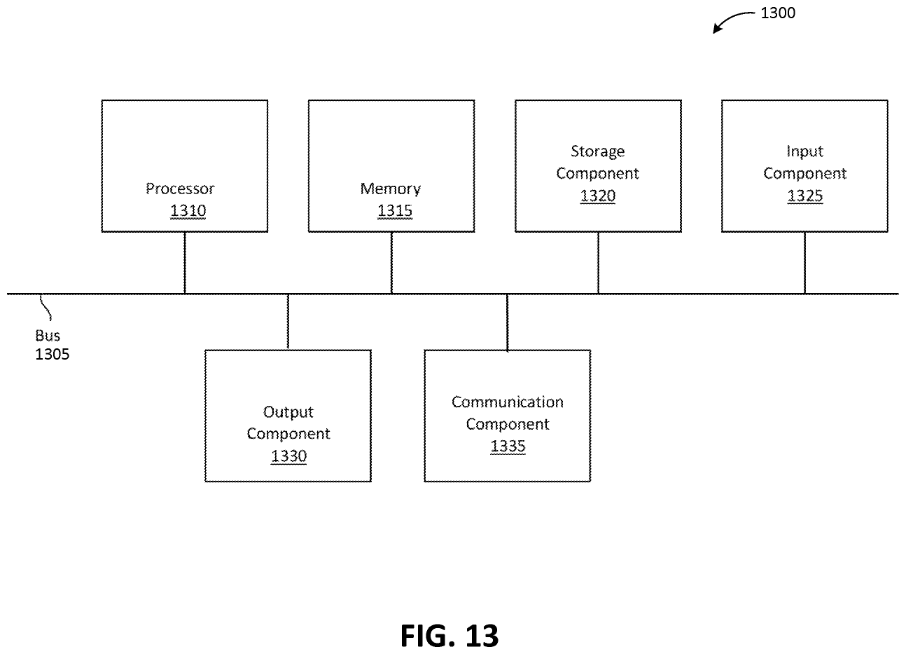

FIG. 13 is a diagram illustrating example components of a device 1300, in accordance with the present disclosure. Device 1300 may correspond to access point 120, wireless device 130 (e.g., an ESL radio and/or ESL controller), and/or management entity 110. In some aspects, access point 120, wireless device 130, and/or management entity 110 may include one or more devices 1300 and/or one or more components of device 1300. As shown in FIG. 13, device 1300 may include a bus 1305, a processor 1310, a memory 1315, a storage component 1320, an input component 1325, an output component 1330, and/or a communication component 1335.

Bus 1305 may include a component that permits communication among the components of device 1300. Processor 1310 may be implemented in hardware, firmware, or a combination of hardware and software. Processor 1310 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some aspects, processor 1310 may include one or more processors capable of being programmed to perform a function. Memory 1315 may include a random access memory (RAM), a read only memory (ROM), and/or another type of dynamic or static storage device (e.g., a flash memory, a magnetic memory, and/or an optical memory) that stores information and/or instructions for use by processor 1310.

Storage component 1320 can store information and/or software related to the operation and use of device 1300. For example, storage component 1320 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 1325 may include a component that permits device 1300 to receive information, such as via user input (e.g., a touch screen display, a keyboard, a keypad, a mouse, a button, a switch, and/or a microphone). Additionally, or alternatively, input component 1325 may include a component for determining a position or a location of device 1300 (e.g., an indoor location component or system that can be based on a plan-o-gram of an environment in which the device 1300 is located, a global positioning system (GPS) component, a global navigation satellite system (GNSS) component, any combination thereof, and/or other location component) and/or a sensor for sensing information (e.g., an accelerometer, a gyroscope, an actuator, or another type of position or environment sensor). Output component 1330 can include a component that provides output information from device 1300 (e.g., a display, a speaker, a haptic feedback component, and/or an audio or visual indicator).

Communication component 1335 may include one or more transceiver-like components (e.g., a transceiver and/or a separate receiver and transmitter) that enable device 1300 to communicate with other devices, such as via a wired connection, a wireless connection, or a combination of wired and wireless connections. Communication component 1335 may permit device 1300 to receive information from another device and/or provide information to another device. For example, communication component 1335 may include an Ethernet interface, an optical interface, a coaxial interface, an infrared interface, a radio frequency interface, a universal serial bus (USB) interface, a wireless local area interface (e.g., a Wi-Fi interface or a BLE interface), and/or a cellular network interface.

Communication component 1335 may include one or more antennas for receiving wireless radio frequency (RF) signals transmitted from one or more other devices, cloud networks, and/or the like. The antenna may be a single antenna or an antenna array (e.g., antenna phased array) that can facilitate simultaneous transmit and receive functionality. The antenna may be an omnidirectional antenna such that signals can be received from and transmitted in all directions. Additionally or alternatively, an antenna array may be used for directional transmission and/or reception of RF signals (e.g., beamforming) as described herein. The wireless signals may be transmitted via a wireless network. The wireless network may be any wireless network, such as a cellular or telecommunications network (e.g., 3G, 4G, 5G, etc.), wireless local area network (e.g., a WiFi network), a Bluetooth® network, and/or other network.

The one or more transceiver-like components (e.g., a wireless transceiver) of the communication component 1335 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end can generally handle the selection and conversion of the wireless signals into a baseband or intermediate frequency and can convert the RF signals to the digital domain.

In some cases, a CODEC may be implemented (e.g., by the processor 1310) to encode and/or decode data transmitted and/or received using the one or more wireless transceivers. In some cases, encryption-decryption may be implemented (e.g., by the processor 1310) to encrypt and/or decrypt data (e.g., according to the Advanced Encryption Standard (AES) and/or Data Encryption Standard (DES) standard) transmitted and/or received by the one or more wireless transceivers.

In some aspects, device 1300 may represent an ESL. The ESL may include a battery in addition to the aforementioned components. In some aspects, the output component 1330 of the ESL may be an electronic paper (e-paper) display or a liquid crystal display (LCD).

Device 1300 may perform one or more processes described herein. Device 1300 may perform these processes based on processor 1310 executing software instructions stored by a non-transitory computer-readable medium, such as memory 1315 and/or storage component 1320. A computer-readable medium is defined herein as a non-transitory memory device. A memory device includes memory space within a single physical storage device or memory space spread across multiple physical storage devices.

Software instructions may be read into memory 1315 and/or storage component 1320 from another computer-readable medium or from another device via communication component 1335. When executed, software instructions stored in memory 1315 and/or storage component 1320 may cause processor 1310 to perform one or more processes described herein. Additionally, or alternatively, hardwired circuitry may be used in place of or in combination with software instructions to perform one or more processes described herein. Thus, aspects described herein are not limited to any specific combination of hardware circuitry and software.

The number and arrangement of components shown in FIG. 13 are provided as an example. In practice, device 1300 may include additional components, fewer components, different components, or differently arranged components than those shown in FIG. 13. Additionally, or alternatively, a set of components (e.g., one or more components) of device 1300 may perform one or more functions described as being performed by another set of components of device 1300.

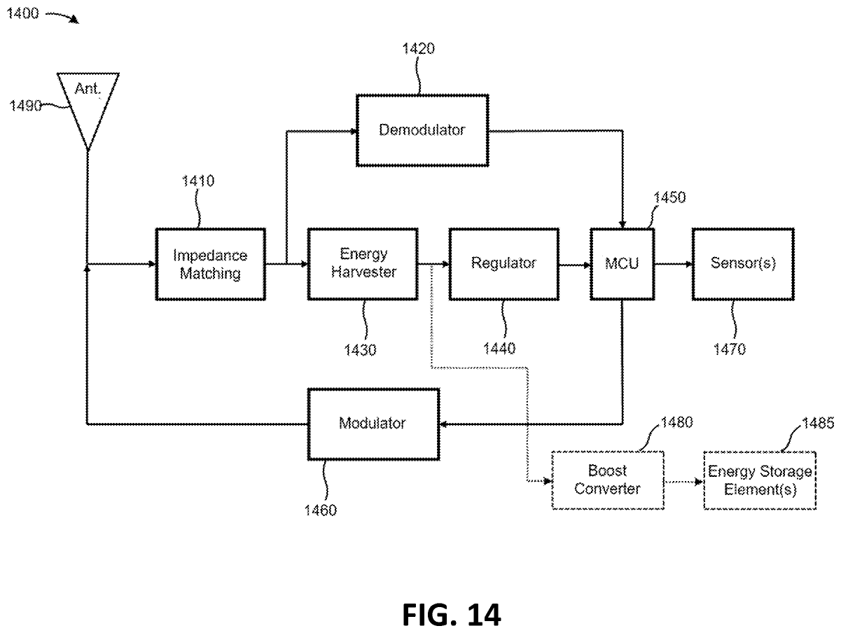

FIG. 14 is an example block diagram of a radio frequency (RF) energy harvesting device 1400, in accordance with some examples. The energy harvesting device 1400 may, for example, correspond to an eTag as described in the embodiments herein. As will be described in greater depth below, the RF energy harvesting device 1400 can harvest RF energy from one or more RF signals received using an antenna 1490. As used herein, the term “energy harvesting” may be used interchangeably with “power harvesting.” In some aspects, energy harvesting device 1400 can be implemented as an Internet-of-Things (IoT) device, can be implemented as a sensor, etc., as will be described in greater depth below. In other examples, energy harvesting device 1400 can be implemented as a Radio-Frequency Identification (RFID) tag or various other RFID devices.

The energy harvesting device 1400 includes one or more antennas 1490 that can be used to transmit and receive one or more wireless signals. For example, energy harvesting device 1400 can use antenna(s) 1490 to receive one or more downlink signals and to transmit one or more uplink signals. An impedance matching component 1410 can be used to match the impedance of antenna(s) 1490 to the impedance of one or more (or all) of the receive components included in energy harvesting device 1400. In some examples, the receive components of energy harvesting device 1400 can include a demodulator 1420 (e.g., for demodulating a received downlink signal), an energy harvester 1430 (e.g., for harvesting RF energy from the received downlink signal), a regulator 1440, a micro-controller unit (MCU) 1450, a modulator 1460 (e.g., for generating an uplink signal). In some cases, the receive components of energy harvesting device 1400 may further include one or more sensors 1470.

The downlink signals can be received from one or more transmitters. For example, energy harvesting device 1400 may receive a downlink signal from a network node or network entity that is included in a same wireless network as the energy harvesting device 1400. In some cases, the network entity can be a base station, gNB, etc., that communicates with the energy harvesting device 1400 using a cellular communication network. For example, the cellular communication network can be implemented according to the 3G, 4G, 5G, and/or other cellular standard (e.g., including future standards such as 6G and beyond).

In some cases, energy harvesting device 1400 can be implemented as a passive or semi-passive energy harvesting device (e.g., an ambient energy harvesting device), which can perform passive uplink communication by modulating and reflecting a downlink signal received via antenna(s) 1490. For example, passive and semi-passive energy harvesting devices may be unable to generate and transmit an uplink signal without first receiving a downlink signal that can be modulated and reflected. In other examples, energy harvesting device 1400 may be implemented as an active energy harvesting device, which utilizes a powered transceiver to perform active uplink communication. An active energy harvesting device is able to generate and transmit an uplink signal without first receiving a downlink signal (e.g., by using an on-device power source to energize its powered transceiver).

An ambient energy harvesting device (e.g., active or semi-passive energy harvesting device) may include one or more energy storage elements 1485 (e.g., collectively referred to as an “energy reservoir”). For example, the one or more energy storage elements 1485 can include batteries, capacitors, etc. In some examples, the one or more energy storage elements 1485 may be associated with a boost converter 1480. The boost converter 1480 can receive as input at least a portion of the energy harvested by energy harvester 1430 (e.g., with a remaining portion of the harvested energy being provided as instantaneous power for operating the energy harvesting device 1400). In some aspects, the boost converter 1480 may be a step-up converter that steps up voltage from its input to its output (e.g., and steps down current from its input to its output). In some examples, boost converter 1480 can be used to step up the harvested energy generated by energy harvester 1430 to a voltage level associated with charging the one or more energy storage elements 1485. An ambient energy harvesting device (e.g., active or semi-passive energy harvesting device) may include one or more energy storage elements 1485 and may include one or more boost converters 1480. A quantity of energy storage elements 1485 may be the same as or different than a quantity of boost converters 1480 included in an active or semi-passive energy harvesting device.

A passive energy harvesting device does not include an energy storage element 1485 or other on-device power source. For example, a passive energy harvesting device may be powered using only RF energy harvested from a downlink signal (e.g., using energy harvester 1430). As mentioned previously, a semi-passive energy harvesting device can include one or more energy storage elements 1485 and/or other on-device power sources. The energy storage element 1485 of a semi-passive energy harvesting device can be used to augment or supplement the RF energy harvested from a downlink signal. In some cases, the energy storage element 1485 of a semi-passive energy harvesting device may store insufficient energy to transmit an uplink communication without first receiving a downlink communication (e.g., minimum transmit power of the semi-passive device > capacity of the energy storage element). An active energy harvesting device can include one or more energy storage elements 1485 and/or other on-device power sources that can power uplink communication without using supplemental harvested RF energy (e.g., minimum transmit power of the active device < capacity of the energy storage element). The energy storage element(s) 1485 included in an active energy harvesting device and/or a semi-passive energy harvesting device can be charged using harvested RF energy.

As mentioned above, ambient energy harvesting devices (e.g., passive and semi-passive energy harvesting devices) transmit uplink communications by performing backscatter modulation to modulate and reflect a received downlink signal. The received downlink signal is used to provide both electrical power (e.g., to perform demodulation, local processing, and modulation) and a carrier wave for uplink communication (e.g., the reflection of the downlink signal). For example, a portion of the downlink signal will be backscattered as an uplink signal and a remaining portion of the downlink signal can be used to perform energy harvesting.

Active energy harvesting devices can transmit uplink communications without performing backscatter modulation and without receiving a corresponding downlink signal (e.g., an active energy harvesting device includes an energy storage element to provide electrical power and includes a powered transceiver to generate a carrier wave for an uplink communication). In the absence of a downlink signal, ambient energy harvesting devices (e.g., passive and semi-passive energy harvesting devices) may be unable to transmit an uplink signal (e.g., passive communication). Active energy harvesting devices do not depend on receiving a downlink signal in order to transmit an uplink signal and can transmit an uplink signal as desired (e.g., active communication).

In examples in which the energy harvesting device 1400 is implemented as an ambient energy harvesting device (e.g., a passive or semi-passive energy harvesting device), a continuous carrier wave downlink signal may be received using antenna(s) 1490 and modulated (e.g., re-modulated) for uplink communication. In some cases, a modulator 1460 can be used to modulate the reflected (e.g., backscattered) portion of the downlink signal. For example, the continuous carrier wave may be a continuous sinusoidal wave (e.g., sine or cosine waveform) and modulator 1460 can perform modulation based on varying one or more of the amplitude and the phase of the backscattered reflection. Based on modulating the backscattered reflection, modulator 1460 can encode digital symbols (e.g., such as binary symbols or more complex systems of symbols) indicative of an uplink communication or data message. For example, the uplink communication may be indicative of sensor data or other information associated with the one or more sensors 1470 included in energy harvesting device 1400.

As mentioned previously, impedance matching component 1410 can be used to match the impedance of antenna(s) 1490 to the receive components of energy harvesting device 1400 when receiving the downlink signal (e.g., when receiving the continuous carrier wave). In some examples, during backscatter operation (e.g., when transmitting an uplink signal), modulation can be performed based on intentionally mismatching the antenna input impedance to cause a portion of the incident downlink signal to be scattered back. The phase and amplitude of the backscattered reflection may be determined based on the impedance loading on the antenna(s) 1490. Based on varying the antenna impedance (e.g., varying the impedance mismatch between antenna(s) 1490 and the remaining components of energy harvesting device 1400), digital symbols and/or binary information can be encoded (e.g., modulated) onto the backscattered reflection. Varying the antenna impedance to modulate the phase and/or amplitude of the backscattered reflection can be performed using modulator 1460.

As illustrated in FIG. 14, a portion of a downlink signal received using antenna(s) 1490 can be provided to a demodulator 1420, which performs demodulation and provides a downlink communication (e.g., carried or modulated on the downlink signal) to a micro-controller unit (MCU) 1450 or other processor included in the energy harvesting device 1400. A remaining portion of the downlink signal received using antenna(s) 1490 can be provided to energy harvester 1430, which harvests RF energy from the downlink signal. For example, energy harvester 1430 can harvest RF energy based on performing AC-to-DC (alternating current-to-direct current) conversion, wherein an AC current is generated from the sinusoidal carrier wave of the downlink signal and the converted DC current is used to power the energy harvesting device 1400. In some aspects, energy harvester 1430 can include one or more rectifiers for performing AC-to-DC conversion. A rectifier can include one or more diodes or thin-film transistors (TFTs). In one illustrative example, energy harvester 1430 can include one or more Schottky diode-based rectifiers. In some cases, energy harvester 1430 can include one or more TFT-based rectifiers.

The output of the energy harvester 1430 is a DC current generated from (e.g., harvested from) the portion of the downlink signal provided to the energy harvester 1430. In some aspects, the DC current output of energy harvester 1430 may vary with the input provided to the energy harvester 1430. For example, an increase in the input current to energy harvester 1430 can be associated with an increase in the output DC current generated by energy harvester 1430. In some cases, MCU 1450 may be associated with a narrow band of acceptable DC current values. Regulator 1440 can be used to remove or otherwise decrease variation(s) in the DC current generated as output by energy harvester 1430. For example, regulator 1440 can remove or smooth spikes (e.g., increases) in the DC current output by energy harvester 1430 (e.g., such that the DC current provided as input to MCU 1450 by regulator 1440 remains below a first threshold). In some cases, regulator 1440 can remove or otherwise compensate for drops or decreases in the DC current output by energy harvester 1430 (e.g., such that the DC current provided as input to MCU 1450 by regulator 1440 remains above a second threshold).

In some aspects, the harvested DC current (e.g., generated by energy harvester 1430 and regulated upward or downward as needed by regulator 1440) can be used to power MCU 1450 and one or more additional components included in the energy harvesting device 1400. For example, the harvested DC current can additionally be used to power one or more (or all) of the impedance matching component 1410, demodulator 1420, regulator 1440, MCU 1450, sensors 1470, modulator 1460, etc. For example, sensors 1470 and modulator 1460 can receive at least a portion of the harvested DC current that remains after MCU 1450 (e.g., that is not consumed by MCU 1450). In some cases, the harvested DC current output by regulator 1440 can be provided to MCU 1450, modulator 1460, and sensors 1470 in series, in parallel, or a combination thereof.

In some examples, sensors 1470 can be used to obtain sensor data (e.g., such as sensor data associated with an environment in which the energy harvesting device 1400 is located). Sensors 1470 can include one or more sensors, which may be of a same or different type(s). In some aspects, one or more (or all) of the sensors 1470 can be configured to obtain sensor data based on control information included in a downlink signal received using antenna(s) 1490. For example, one or more of the sensors 1470 can be configured based on a downlink communication obtained based on demodulating a received downlink signal using demodulator 1420. In one illustrative example, sensor data can be transmitted based on using modulator 1460 to modulate (e.g., vary one or more of amplitude and/or phase of) a backscatter reflection of the continuous carrier wave received at antenna(s) 1490. Based on modulating the backscattered reflection, modulator 1460 can encode digital symbols (e.g., such as binary symbols or more complex systems of symbols) indicative of an uplink communication or data message. In some examples, modulator 1460 can generate an uplink, backscatter modulated signal based on receiving sensor data directly from sensors 1470. In some examples, modulator 1460 can generate an uplink, backscatter modulated signal based on received sensor data from MCU 1450 (e.g., based on MCU 1450 receiving sensor data directly from sensors 1470).

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1: A method at a management entity of coordinating communication from a plurality of wireless devices, the method comprising: determining a first query list for querying a first subset of the plurality of wireless devices for positioning information of one or more target devices, the first query list based at least in part on one or more characteristics of the plurality of wireless devices; receiving the positioning information of one or more target devices responsive to one or more queries to the first subset of the plurality of wireless devices, the positioning information comprising measurements of radio frequency (RF) signals transmitted by the one or more target devices, the measurements made by at least one wireless device of the first subset of the plurality of wireless devices; and determining a second query list for querying a second subset of the plurality of wireless devices for additional positioning information of the one or more target devices, the second query list based at least in part on the positioning information of one or more target devices.

Clause 2: The method of clause 1, wherein the first query list comprises, for each wireless device of the first subset of the plurality of wireless devices: an identifier of the respective wireless device, and a maximum allowable duration for transmitting a query response.

Clause 3: The method of either of clauses 1 or 2, wherein the one or more characteristics of the plurality of wireless devices comprises: a location, a battery level, or both.

Clause 4: The method of any one of clauses 1-3, wherein the second query list is based at least in part on: a distance of each wireless device of the second subset of the plurality of wireless devices from the one or more target devices, a priority associated with the one or more target devices, an allowable duration of each wireless device of the second subset of the plurality of wireless devices for transmitting a query response, an accuracy for positioning the one or more target devices, an amount of data of each wireless device of the second subset of the plurality of wireless devices to report, an Rx scanning pattern of each wireless device of the second subset of the plurality of wireless devices, or any combination thereof.

Clause 5: The method of any one of clauses 1-4, further comprising: sending the first query list to one or more access points (APs) prior to receiving the positioning information; receiving the positioning information from the one or more APs; and sending the second query list to the one or more APs.

Clause 6: The method of any one of clauses 1-5, further comprising determining a group allocation for the plurality of wireless devices, wherein the group allocation: divides the plurality of wireless devices into spatially separated groups based on known locations of the plurality of wireless devices.

Clause 7: The method of clause 6, further comprising sending the group allocation to one or more APs prior to determining the first query list.

Clause 8: The method of any one of clauses 6-7, wherein the group allocation is based on a distance value between wireless devices of the groups, information regarding an environment in which the plurality of wireless devices is located, or both.

Clause 9: The method of any one of clauses 1-8, wherein the measurements made by the at least one wireless device comprise a portion of a larger set of measurements performed by the at least one wireless device, the portion obtained by filtering the larger set of measurements.

Clause 10: The method of any one of clauses 1-9, wherein the filtering of the larger set of measurements is based at least in part on: measurement age, measurement type, measurement value, an uncertainty metric, measurement statistics, a target device type, or any combination thereof.

Clause 11: A management entity comprising: at least one transceiver; at least one memory; and at least one processor communicatively coupled with the at least one transceiver and the at least one memory, the at least one processor configured to: determine a first query list for querying a first subset of a plurality of wireless devices for positioning information of one or more target devices, the first query list based at least in part on one or more characteristics of the plurality of wireless devices; receive, via the at least one transceiver, the positioning information of one or more target devices responsive to one or more queries to the first subset of the plurality of wireless devices, the positioning information comprising measurements of radio frequency (RF) signals transmitted by the one or more target devices, the measurements made by at least one wireless device of the first subset of the plurality of wireless devices; and determine a second query list for querying a second subset of the plurality of wireless devices for additional positioning information of the one or more target devices, the second query list based at least in part on the positioning information of one or more target devices.

Clause 12: The management entity of clause 11, wherein the at least one processor is configured to include, in the first query list, for each wireless device of the first subset of the plurality of wireless devices: an identifier of the respective wireless device, and a maximum allowable duration for transmitting a query response.

Clause 13: The management entity of either of clauses 11 or 12, wherein the one or more characteristics of the plurality of wireless devices comprises: a location, a battery level, or both.

Clause 14: The management entity of any one of clauses 11-13, wherein the at least one processor is configured to base the second query list at least in part on: a distance of each wireless device of the second subset of the plurality of wireless devices from the one or more target devices, a priority associated with the one or more target devices, an allowable duration of each wireless device of the second subset of the plurality of wireless devices for transmitting a query response, an accuracy for positioning the one or more target devices, an amount of data of each wireless device of the second subset of the plurality of wireless devices to report, an Rx scanning pattern of each wireless device of the second subset of the plurality of wireless devices, or any combination thereof.

Clause 15: The management entity of any one of clauses 11-14, wherein the at least one processor is further configured to: send the first query list, via the at least one transceiver, to one or more access points (APs) prior to receiving the positioning information; receive the positioning information from the one or more APs; and send the second query list to the one or more APs.

Clause 16: The management entity of any one of clauses 11-15, wherein the at least one processor is further configured to determine a group allocation for the plurality of wireless devices that divides the plurality of wireless devices into spatially separated groups based on known locations of the plurality of wireless devices.

Clause 17: The management entity of clause 16, wherein the at least one processor is further configured to send the group allocation, via the at least one transceiver, to one or more APs prior to determining the first query list.

Clause 18: The management entity of any one of clauses 16-17, wherein the at least one processor is further configured to determine the group allocation based on a distance value between wireless devices of the groups, information regarding an environment in which the plurality of wireless devices is located, or both.

Clause 19: The management entity of any one of clauses 11-18, wherein the measurements made by the at least one wireless device comprise a portion of a larger set of measurements performed by the at least one wireless device, the portion obtained by filtering the larger set of measurements.

Clause 20: The management entity of any one of clauses 11-19, wherein the filtering of the larger set of measurements is based at least in part on: measurement age, measurement type, measurement value, an uncertainty metric, measurement statistics, a target device type, or any combination thereof.

Clause 21: An apparatus having means for performing the method of any one of clauses 1-20.

Clause 22: A non-transitory computer-readable medium storing instructions, the instructions comprising code for performing the method of any one of clauses 1-20.

What is claimed is:

1. A method at a management entity of coordinating communication from a plurality of wireless devices, the method comprising:
determining a first query list for querying a first subset of the plurality of wireless devices for positioning information of one or more target devices, the first query list based at least in part on one or more characteristics of the plurality of wireless devices;
receiving the positioning information of one or more target devices responsive to one or more queries to the first subset of the plurality of wireless devices, the positioning information comprising measurements of radio frequency (RF) signals transmitted by the one or more target devices, the measurements made by at least one wireless device of the first subset of the plurality of wireless devices; and
determining a second query list for querying a second subset of the plurality of wireless devices for additional positioning information of the one or more target devices, the second query list based at least in part on the positioning information of one or more target devices.

2. The method of claim 1, wherein the first query list comprises, for each wireless device of the first subset of the plurality of wireless devices:
an identifier of the respective wireless device, and
a maximum allowable duration for transmitting a query response.

3. The method of claim 1, wherein the one or more characteristics of the plurality of wireless devices comprises:
a location,
a battery level, or
both.

4. The method of claim 1, wherein the second query list is based at least in part on:
a distance of each wireless device of the second subset of the plurality of wireless devices from the one or more target devices,
a priority associated with the one or more target devices,
an allowable duration of each wireless device of the second subset of the plurality of wireless devices for transmitting a query response,
an accuracy for positioning the one or more target devices,
an amount of data of each wireless device of the second subset of the plurality of wireless devices to report,
an Rx scanning pattern of each wireless device of the second subset of the plurality of wireless devices, or
any combination thereof.

5. The method of claim 1, further comprising:
sending the first query list to one or more access points (APs) prior to receiving the positioning information;
receiving the positioning information from the one or more APs; and
sending the second query list to the one or more APs.

6. The method of claim 1, further comprising determining a group allocation for the plurality of wireless devices, wherein the group allocation
divides the plurality of wireless devices into spatially separated groups based on known locations of the plurality of wireless devices.

7. The method of claim 6, further comprising sending the group allocation to one or more APs prior to determining the first query list.

8. The method of claim 6, wherein the group allocation is based on a distance value between wireless devices of the groups, information regarding an environment in which the plurality of wireless devices is located, or both.

9. The method of claim 1, wherein the measurements made by the at least one wireless device comprise a portion of a larger set of measurements performed by the at least one wireless device, the portion obtained by filtering the larger set of measurements.

10. The method of claim 9, wherein the filtering of the larger set of measurements is based at least in part on:
measurement age,
measurement type,
measurement value,
an uncertainty metric,
measurement statistics,
a target device type, or
any combination thereof.

11. A management entity comprising:
at least one transceiver;
at least one memory; and
at least one processor communicatively coupled with the at least one transceiver and the at least one memory, the at least one processor configured to:
determine a first query list for querying a first subset of a plurality of wireless devices for positioning information of one or more target devices, the first query list based at least in part on one or more characteristics of the plurality of wireless devices;
receive, via the at least one transceiver, the positioning information of one or more target devices responsive to one or more queries to the first subset of the plurality of wireless devices, the positioning information comprising measurements of radio frequency (RF) signals transmitted by the one or more target devices, the measurements made by at least one wireless device of the first subset of the plurality of wireless devices; and
determine a second query list for querying a second subset of the plurality of wireless devices for additional positioning information of the one or more target devices, the second query list based at least in part on the positioning information of one or more target devices.

12. The management entity of claim 11, wherein the at least one processor is configured to include, in the first query list, for each wireless device of the first subset of the plurality of wireless devices:
an identifier of the respective wireless device, and
a maximum allowable duration for transmitting a query response.

13. The management entity of claim 11, wherein the one or more characteristics of the plurality of wireless devices comprises:
a location,
a battery level, or
both.

14. The management entity of claim 11, wherein the at least one processor is configured to base the second query list at least in part on:
a distance of each wireless device of the second subset of the plurality of wireless devices from the one or more target devices,
a priority associated with the one or more target devices,
an allowable duration of each wireless device of the second subset of the plurality of wireless devices for transmitting a query response, an accuracy for positioning the one or more target devices,
an amount of data of each wireless device of the second subset of the plurality of wireless devices to report,
an Rx scanning pattern of each wireless device of the second subset of the plurality of wireless devices, or
any combination thereof.

15. The management entity of claim 11, wherein the at least one processor is further configured to:
send the first query list, via the at least one transceiver, to one or more access points (APs) prior to receiving the positioning information;
receive the positioning information from the one or more APs; and
send the second query list to the one or more APs.

16. The management entity of claim 11, wherein the at least one processor is further configured to determine a group allocation for the plurality of wireless devices that divides the plurality of wireless devices into spatially separated groups based on known locations of the plurality of wireless devices.

17. The management entity of claim 16, wherein the at least one processor is further configured to send the group allocation, via the at least one transceiver, to one or more APs prior to determining the first query list.

18. The management entity of claim 16, wherein the at least one processor is further configured to determine the group allocation based on a distance value between wireless devices of the groups, information regarding an environment in which the plurality of wireless devices is located, or both.

19. The management entity of claim 11, wherein the measurements made by the at least one wireless device comprise a portion of a larger set of measurements performed by the at least one wireless device, the portion obtained by filtering the larger set of measurements.

20. An apparatus comprising:
means for determining a first query list for querying a first subset of a plurality of wireless devices for positioning information of one or more target devices, the first query list based at least in part on one or more characteristics of the plurality of wireless devices;
means for receiving the positioning information of one or more target devices responsive to one or more queries to the first subset of the plurality of wireless devices, the positioning information comprising measurements of radio frequency (RF) signals transmitted by the one or more target devices, the measurements made by at least one wireless device of the first subset of the plurality of wireless devices; and
means for determining a second query list for querying a second subset of the plurality of wireless devices for additional positioning information of the one or more target devices, the second query list based at least in part on the positioning information of one or more target devices.
